(19) United States
(12) Patent Application Publication
(10) Pub. No.: US 2010/0261801 A1
(43) Pub. Date: Oct. 14, 2010

(54) METHOD FOR MAKING A FUNCTIONALIZED MEMBRANE

(75) Inventors: Douglas E. Weiss, Golden Valley, MN (US); Clinton P. Wailer, JR., White Bear Lake, MN (US); Derek J. Dehn, Maplewood, MN (US); Jonathan Hester, Hudson, WI (US)

Correspondence Address: 3M INNOVATIVE PROPERTIES COMPANY, PO BOX 33427, ST. PAUL, MN, 55133-3427, US

(73) Assignee: 3M INNOVATIVE PROPERTIES COMPANY, Saint Paul, MN (US)

(21) Appl. No.: 12/808,010

(22) PCT Filed: Dec. 23, 2008
(86) PCT No.: PCT/US08/88106

§ 371 Date: Jun. 14, 2010

Related U.S. Application Data
(60) Provisional application No. 61/017,041, filed on Dec. 27, 2007.

(51) Int. Cl. C08J 5/22

(52) U.S. Cl. 521/27

(57) ABSTRACT

The present disclosure describes functional membranes and a method for making a functional membrane. The method includes providing a porous substrate, applying the at least one graftable species to the porous substrate, and treating the coated porous substrate with electron beam radiation to provide a functionalized membrane. The method includes forming a functionalized membrane comprising a gradient of grafted species attached to the porous substrate.

### FIELD

The present disclosure relates to functionalized membranes and to methods for making such functionalized membranes.

### BACKGROUND

Membranes having diverse properties have been used in many modern products including such things as filters, breathable articles, absorbent articles and medical articles. There are many known methods for manufacturing membranes.

Membranes having different chemical or physical functionality have been described. Grafting of molecules onto substrates is one method to provide functionality to membrane surfaces. There is a need in the art for improved membranes and methods for making such membranes.

### SUMMARY

The present disclosure provides functionalized membranes and methods for making such membranes.

In a first aspect, a method is provided for making a functionalized membrane. The method includes providing a porous substrate having a first major surface, interstitial surfaces, and a second major surface. The method includes applying at least one graftable species to the porous substrate to provide a coated porous substrate. The method includes treating the coated porous substrate with electron beam radiation to provide the functionalized membrane. The electron beam radiation attaches the graftable species to the porous substrate in a gradient so that the concentration of grafted species is greater at the first major surface than at the second major surface.

In another aspect, a method is provided for making the foregoing functionalized membrane, but the coated porous substrate is positioned between a first layer and a second layer to form a multilayer structure. The multilayer structure is then treated with electron beam radiation to provide the functionalized membrane positioned between the first layer and the second layer. The first layer and the second layer are removed from the multilayer structure to provide the functionalized membrane.

In still another aspect, a functionalized membrane is provided. The functionalized membrane comprises a porous substrate having grafted species attached to the porous substrate in a gradient. The porous substrate has a first major surface, interstitial surfaces, and a second major surface. The grafted species are attached to the porous substrate in a gradient extending through the porous substrate from the first major surface to the second major surface. The concentration of grafted species is greater at the first major surface than at the second major surface of the porous substrate.

### BRIEF DESCRIPTION OF THE DRAWINGS

FIG. 1 is a graph showing a simulated electron beam radiation dose vs. unit path length as a function of voltage.

### DETAILED DESCRIPTION

Unless otherwise noted, terms used in describing the present disclosure will be understood to have meaning consistent with the understanding of those skilled in the art. As used herein, the following terms, shall have the meaning set forth herein.

The recitation of numerical ranges by endpoints includes all numbers subsumed within that range (e.g., 1 to 5 includes 1, 1.5, 2, 2.75, 3, 3.8, 4, and 5).

As included in this specification and the appended claims, the singular forms “a”, “an”, and “the” include plural referents unless the content clearly dictates otherwise. Thus, for example, reference to a composition containing “a compound” includes a mixture of two or more compounds. As used in this specification and appended claims, the term “or” is generally employed in its sense including “and/or” unless the content clearly dictates otherwise.

Unless otherwise indicated, all numbers expressing quantities or ingredients, measurement of properties and so forth used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings of the present disclosure. At the very least, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains errors necessarily resulting from the standard deviations found in their respective testing measurements.

The present disclosure provides functionalized membranes and methods for making functionalized membranes. The methods of this disclosure include providing a porous substrate, applying at least one graftable species to the coated porous substrate, and treating the coated porous substrate with electron beam radiation. The porous substrate comprises a first major surface, interstitial surfaces extending into and/or through the body of the substrate and a second major surface. The interstitial surfaces include the surfaces within the openings or pores of the porous substrate. The porous substrate is treated with at least one graftable species to provide a coated porous substrate. The coated porous substrate is treated with electron beam radiation. The amount of radiation (e.g., energy) delivered to the coated porous substrate can be controlled by adjusting the current (mA) at the electron beam source. The depth of penetration from the electron beam source is controlled by adjusting the voltage (keV) such that the dose of radiation delivered to the first major surface is greater than the dose of radiation delivered to the second major surface of the coated porous substrate. In other words, a gradient dose of radiation is delivered throughout the thickness of the coated porous substrate. Upon exposure to radiation, the at least one graftable species attaches to the coated porous substrate to form a functionalized membrane having a gradient of grafted species attached to the porous substrate. The gradient of grafted species extends through the thickness of the porous substrate extending from the first major surface to the second major surface of the functionalized membrane. The concentration of grafted species of the functionalized membrane is greater at the first major surface than at the second major surface. An asymmetric membrane is provided having a gradient of grafted species distributed through the thickness of the membrane.

In another embodiment, a method for making the foregoing functionalized membrane is provided wherein the porous substrate is coated with at least one graftable species to provide a coated porous substrate as previously described. The coated porous substrate is then positioned between a first layer and a second layer to form a multilayer structure. The multilayer structure is exposed to electron beam radiation to form a functionalized membrane positioned between the first layer and the second layer. A gradient dose of radiation is delivered throughout the thickness of the multilayer structure to form a functionalized membrane comprising a gradient of grafted species attached to the substrate distributed from the first major surface to the second major surface of the functionalized membrane with the concentration of grafted species being greater at the first major surface than at the second major surface. The first layer and the second layer are removed from the multilayer structure to provide the functionalized membrane.

Suitable porous substrate may be selected from a variety of materials so long as the substrate is coatable or can be adapted to be coatable, and comprises openings or pores. Suitable porous substrates include, but are not limited to, porous membranes, porous nonwoven webs, and porous fibers. The porous substrate may be formed from any polymeric material. Suitable polymeric materials include, but are not limited to, polyolefins, poly(isoprenes), poly(butadienes), fluorinated polymers, chlorinated polymers, polyesters, polyamides, polyimides, polyethers, poly(ether sulfones), poly(sulfones), polyphenylene oxides, polyphenylene sulfides, poly(vinyl acetates), copolymers of vinyl acetate, poly (phosphazenes), poly(vinyl esters), poly(vinyl ethers), poly(vinyl alcohols) and poly(carbonates). Suitable polyolefins include, but are not limited to, poly(ethylene), poly(propylene), poly(1-butene), copolymers of ethylene and propylene, alpha olefin copolymers (such as copolymers of 1-butene, 1-hexene, 1-octene, and 1-decene), poly(ethylene-co-1-butene) and poly(ethylene-co-1-butene-co-1-hexene). Suitable fluorinated polymers include, but are not limited to, poly(vinyl fluoride), poly(vinylidene fluoride), copolymers of vinylidene fluoride (such as poly(vinylidene fluoride-co-hexafluoropropylene)), and copolymers of chlorotrifluoroethylene (such as poly(ethylene-co-chlorotrifluoroethylene)). Suitable polyamides include, but are not limited to, poly(imino(1-oxohexamethylene)), poly(iminoadipoyliminohexamethylene), poly(iminoadipoyliminodecamethylene), and polycaprolactam. Suitable polyimides include, but are not limited to, poly(pyromellitimide). Suitable poly(ether sulfone)s include, but are not limited to, poly(diphenylether sulfone), and poly(diphenylsulfone-co-diphenylene oxide sulfone). Suitable copolymers of vinyl acetate include, but are not limited to, poly(ethylene-co-vinyl acetate) and such copolymers in which at least some of the acetate groups have been hydrolyzed to afford various poly(vinyl alcohols).

In some embodiments, the porous substrate has an average pore size less than about 10 micrometers. In some embodiments, the average pore size of the porous substrate is greater than about 10 nanometers. Suitable porous substrates include, but are not limited to, nanoporous membranes, microporous membranes, microporous nonwoven webs, and microporous fibers. In some embodiments, the porous substrate can have a combination of different pore sizes (e.g., macropores, micropores, nanopores). In some embodiments, the porous substrate comprises two or more distinct porous zones or regions (e.g., multizone membranes).

In some embodiments, the porous substrate is hydrophobic and comprises one or more of the above-mentioned polymeric materials.

In some embodiments, the porous substrate is a hydrophilic porous membrane such as a thermally-induced phase separation (TIPS) membrane. TIPS membranes are often prepared by forming a solution of a thermoplastic material and a second material above the melting point of the thermoplastic material. Upon cooling, the thermoplastic material crystallizes and phase separates from the second material. The crystallized material is often stretched. The second material is optionally removed either before or after stretching. TIPS membranes are disclosed in U.S. Pat. Nos. 1,529,256 (Kelley); 4,726,989 (Mrozinski); 4,867,881 (Kinzer); 5,120,594 (Mrozinski); 5,260,360 (Mrozinski); and 5,962,544 (Waller, Jr.), herein incorporated by reference. In some embodiments, TIPS membranes comprise polymeric materials such as poly(vinylidene fluoride) (i.e., PVDF), polyolefins such as poly(ethylene) or poly(propylene), vinyl-containing polymers or copolymers such as ethylene-vinyl alcohol copolymers and butadiene-containing polymers or copolymers, and acrylate-containing polymers or copolymers. TIPS membranes comprising PVDF are further described in U.S. Patent Application Publication No. 2005/0058821 (Smith et al.), herein incorporated by reference.

In some embodiments, the porous substrate is a non-woven web having an average pore size that is typically greater than 25 micrometers. Suitable nonwoven webs include, for example, the melt-blown microfiber nonwoven webs described in Wente, V. A., “Superfine Thermoplastic Fibers”; Industrial Engineering Chemistry, 48, 1342-1346 (1956), and Wente, V. A., “Manufacture of Super Fine Organic Fibers”; Naval Research Laboratories (Report No. 4364). May 25, 1954. For example, the non-woven web can be prepared from ethylene-vinyl alcohol copolymers as described in U.S. Pat. No. 5,962,544 (Waller, Jr.), herein incorporated by reference. In some embodiments, suitable non-woven webs can be prepared from nylon.

Suitable porous substrates include commercially available materials such as hydrophilic and hydrophobic microporous membranes known under the trade designations DURAPORE and MILLIPORE EXPRESS MEMBRANE, available from Millipore Corporation of Billerica, Mass. Other suitable commercial microporous membranes known under the trade designations NYLAFLO and SUPOR are available from Pall Corporation of East Hills, N.Y. Some other porous substrates have been described in U.S. Pat. Nos. 6,513,666; 6,776,940; 6,413,070; 6,264,044; 3,876,738; 4,707,265; 4,473,474; and U.S. Defensive Publication T-103,601, herein incorporated by reference.

At least one graftable species is applied to the porous substrate. The term “at least one graftable species” generally refers to one or more than one graftable species capable of attaching to the porous substrate when exposed to electron beam radiation. The graftable species can attach to a first major surface, interstitial surfaces (e.g., within the porous substrate), and to a second major surface of the porous substrate, all as described herein. The graftable species may attach to the porous substrate by chemical bonding (e.g., free radical reaction) to form a covalent bond. Upon attachment of the graftable species to the porous substrate, a functionalized membrane is formed comprising grafted species attached to the porous substrate. The surface properties of the functionalized membrane may be different than the surface properties of the porous substrate upon attachment of the graftable species. Similarly, the reactivity of the functionalized membrane may be different than of the porous substrate. For example, the grafted species of the porous substrate may provide reactivity occurring by hydrogen bonding, Van der Waals interactions, or by ionic bonding.

In some embodiments, the graftable species can have a free-radically polymerizable group and an additional functional group thereon. The free-radically polymerizable group can be an ethylenically unsaturated group such as a (meth)acryloyl group or a vinyl group. The free-radically polymerizable group typically can react with the surface of the porous substrate when exposed to electron beam radiation. The reaction of the free-radically polymerizable groups of the graftable species with on or more of the surfaces of the porous substrate upon exposure to electron beam radiation results in the formation of a gradient of grafted species attached (e.g., covalently bonded) to the surfaces of the porous substrate with one or more grafted species attached to the first major surface, interstitial surfaces and second major surface of the porous substrate thus providing a functionalized membrane.

In one embodiment, the functionalized membrane comprises a first major surface and a second major surface, both of the major surfaces being hydrophilic with grafted species attached to the porous substrate at a greater concentration at the first major surface than at the second major surface.

In some embodiments, the functionalized membrane can be physically asymmetric. Some useful asymmetric microporous membranes are disclosed in U.S. Pat. Nos. 6,413,070; 6,513,666; and 6,264,044 (Meyering et al.), each incorporated by reference. For example, the porosity or the effective pore size at the first major surface can be different than the porosity or the effective pore size at the second major surface such that the grafted species forms a gel at one major surface or through at least a portion of the thickness of the porous substrate. In such embodiments, the gradient of grafted species may contribute to at least partially blocking the pores on one major surface and increasing pore sizes extending to a second major surface of the functionalized membrane.

In addition to having a free-radically polymerizable group, graftable species may contain a second or additional functional group. In some embodiments, the second functional group is selected from a second ethylenically unsaturated group, ring opening groups (e.g., epoxy group, an azlactone group, and an aziridine group), an isocyanato group, an ionic group, an alkylene oxide group, or combinations thereof. The second or additional functional group can provide for further reactivity or affinity of the grafted species. For example, the additional functional group can react to form a linking group between the porous substrate and other material such as other species or nucleophilic compounds having at least one nucleophilic group.

The presence of an additional functional group can impart a desired surface property to the functionalized membrane such as affinity for a particular type of compound. If the grafted species contains an ionic group, the functionalized membrane will often have an affinity for compounds having an opposite charge. That is, compounds with negatively charged groups can be attracted to a functionalized membrane having grafted species with a cationic group and compounds with positively charged groups can be attracted to a functionalized membrane having grafted species with an anionic group. Further, the grafted species can impart a hydrophilic property to a surface of the functionalized membrane that includes is hydrophobic prior to surface modification by the grafted species. In one embodiment, the grafted species containing an alkylene oxide group can impart hydrophilic character to the functionalized membrane.

In another embodiment, the porous substrate can have a hydrophilic property prior to surface modification with the graftable species. Following attachment to the porous substrate, the grafted species can impart a hydrophobic property to the surface of the functionalized membrane.

In some embodiments, the graftable species have a free-radically polymerizable group that is a first ethylenically unsaturated group and a second functional group that is a second ethylenically unsaturated group. Suitable graftable species having two ethylenically unsaturated groups include, but are not limited to, polyalkylene glycol di(meth)acrylates. The term polyalkylene glycol di(meth)acrylate is used interchangeably with the term polyalkylene oxide di(meth)acrylate. The term “(meth)acryl” as in (meth)acrylate is used to encompass both acryl groups as in acrylates and methacryl groups as in methacrylates. Exemplary polyalkylene glycol di(meth)acrylates include polyethylene glycol di(meth)acrylate species and polypropylene glycol di(meth)acrylate species. Polyethylene glycol diacrylate species having an average molecular weight of about 400 g/mole is commercially available, for example, under the trade designation SR344 and polyethylene glycol dimethacrylate species having an average molecular weight of about 400 g/mole is commercially available under the trade designation SR603 from Sartomer Co., Inc. of Exton, Pa.

In another embodiment, a gradient of grafted species result from the reaction of polyethylene glycol di(meth)acrylate species with the porous substrate upon exposure to electron beam radiation. These graftable species can be used to modify a hydrophobic porous substrate to form a hydrophilic functionalized membrane having polyalkylene oxide groups on one or more of the first major surface, interstitial surfaces or second major surface. In another embodiment, the polyethylene glycol di(meth)acrylate species comprises a polyethylene glycol dimethacrylate species (e.g., polyethylene glycol dimethacrylate having an average molecular weight of about 400 g/mole) alone or in combination with other species.

In some embodiments, suitable graftable species have a free-radically polymerizable group that is a first ethylenically unsaturated group and an additional functional group that is an epoxy group. Suitable graftable species within this class include, but are not limited to, glycidyl (meth)acrylates. This class of graftable species can provide a functionalized membrane having at least one epoxy group available for further reactivity. The epoxy group can react with other reactants such as with another species or with a nucleophilic compound to impart a desired surface property to the porous substrate (e.g., affinity for a particular compound or functional group having different reactivity). The reaction of the epoxy group with a nucleophilic compound, for example, results in the opening of the epoxy ring and the formation of a linkage group that functions to tether the nucleophilic compound to the porous substrate. Suitable nucleophilic groups for reacting with epoxy groups include, but are not limited to, primary amino groups, secondary amino groups, and carboxy groups. The nucleophilic compound can contain more than one nucleophilic group that can crosslink multiple epoxy groups or more than one optional groups that can impart hydrophilic character to the functionalized membrane. The linkage group formed by ring-opening of the epoxy group often contains the group —C(OH)HCH₂NH— when the epoxy is reacted with a primary amino group or —C(OH)HCH₂O(CO)— when the epoxy is reacted with a carboxy group.

In some instances, the epoxy groups can be reacted with a multifunctional amine such as a diamine having two primary amino groups or a triamine having three primary amino groups. One of the amino groups can undergo a ring opening reaction with the epoxy group and result in the formation of a linkage group that contains the group —C(OH)HCH₂NH— between the nucleophilic compound and the porous substrate. The second amino group or the second and third amino groups can impart a hydrophilic character to the functionalized membrane or can crosslink two or more grafted species by reacting with one or more additional epoxy groups. In some examples, the multifunctional amine is a polyalkylene glycol diamine or polyalkylene glycol triamine and reaction with an epoxy group results in the attachment of a grafted species having a polyalkylene glycol group (i.e., polyalkylene oxide group). The polyalkylene glycol group as well as any terminal primary amino group tends to impart a hydrophilic character to the membrane.

In still other embodiments, suitable graftable species have a free-radically polymerizable group that is an ethylenically unsaturated group and an additional functional group that is an azlactone group. Suitable graftable species include, but are not limited to, vinyl azlactone such as 2-vinyl-4,4-dimethylazlactone. This class of graftable species can provide a functionalized membrane having at least one azlactone group available for further reactivity. The azlactone group can react with other reactants such as another species or with a nucleophilic compound to impart a desired surface property to the porous substrate (e.g., affinity for a particular compound or functional group having different reactivity). The reaction of the azlactone group with a nucleophilic compound, for example, results in the opening of the azlactone ring and the formation of a linkage group that functions to attach the nucleophilic compound to the porous substrate. The nucleophilic compound typically contains at least one nucleophilic group. Suitable nucleophilic groups for reacting with an azlactone group include, but are not limited to, primary amino groups, secondary amino groups and hydroxy groups. The nucleophilic compound can contain additional nucleophilic groups that can crosslink multiple azlactone groups or can contain other optional groups that can impart a hydrophilic character to the functionalized membrane. The linkage group formed by ring-opening of the azlactone group often contains the group —(CO)NHCR₂(CO)— where R is an alkyl such as methyl and (CO) denotes a carbonyl.

In some instances, the azlactone groups can be reacted with a multifunctional amine such as a diamine having two primary amino groups or a triamine having three primary amino groups. One of the amino groups can undergo a ring opening reaction with the azlactone group and result in the formation of a linkage containing the group —(CO)NHCR₂(CO)— between the nucleophilic compound and the porous substrate. The second amino group or second and third amino groups can impart a hydrophilic character to the functionalized membrane or can crosslink multiple grafted species. In some examples, the multifunctional amine is a polyalkylene glycol diamine or a polyalkylene glycol triamine and reaction with an azlactone group results in the attachment of a grafted species having a polyalkylene glycol group (i.e., polyalkylene oxide group). The polyalkylene glycol group as well as any terminal primary amino group tends to impart a hydrophilic character to the functionalized membrane.

In still other embodiments, suitable graftable species have a free-radically polymerizable group that is an ethylenically unsaturated group and an additional functional group that is an isocyanato group. Suitable graftable species include, but are not limited to an isocyanatoalkyl (meth)acrylate such as 2-isocyanatoethyl methacrylate and 2-isocyanatoethyl acrylate. This class of graftable species can provide a functionalized membrane having at least one isocyanato group available for reactivity. The isocyanato group can react with other reactants such as another species or with a nucleophilic compound to impart a desired surface property to the porous substrate (e.g., affinity for a particular compound or functional group having different reactivity). The reaction of an isocyanato group with a nucleophilic compound can result in the formation of a urea linkage if the nucleophilic group is a primary amino or secondary amino group or in the formation of a urethane linkage if the nucleophilic group is a hydroxy group. The nucleophilic compound can contain additional nucleophilic groups that can crosslink multiple isocyanato groups or can contain other optional groups that can impart a hydrophilic character to the functionalized membrane. The linkage group formed by reaction of a nucleophilic compound with an isocyanato group often contains the group —NH(CO)NH— when the nucleophilic group is a primary amino group or —NH(CO)O— when the nucleophilic group is a hydroxy.

In still other embodiments, suitable graftable species have a free-radically polymerizable group that is an ethylenically unsaturated group and an additional functional group that is an ionic group. The ionic group can have a positive charge, a negative charge, or a combination thereof. With some suitable ionic species, the ionic group can be neutral or charged depending on the pH conditions. This class of species is typically used to impart a desired surface affinity for one or more oppositely charged compounds or to decrease the affinity for one or more similarly charged compounds.

In still other embodiments, suitable ionic graftable species having a negative charge include (meth)acrylamidosulfonic acids of Formula I or salts thereof.

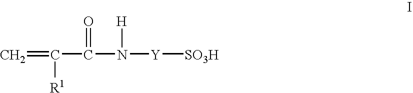

In Formula I, R¹ is hydrogen or methyl; and Y is a straight or branched alkylene (e.g., an alkylenes having 1 to 10 carbon atoms, 1 to 6 carbon atoms, or 1 to 4 carbon atoms). Exemplary ionic species according to Formula I include, but are not limited to, N-acrylamidomethanesulfonic acid, 2-acrylamidoethanesulfonic acid, 2-acrylamido-2-methyl-1-propanesulfonic acid, and 2-methacrylamido-2-methyl-1-propanesulfonic acid. Salts of these acidic species can also be used. Counter ions for the salts can be, for example, ammonium ions, potassium ions, lithium ions, or sodium ions.

Other suitable ionic graftable species having a negative charge include sulfonic acids such as vinylsulfonic acid and 4-styrenesulfonic acid; (meth)acrylamidophosphonic acids such as (meth)acrylamidoalkylphosphonic acids (e.g., 2-acrylamidoethylphosphonic acid and 3-methacrylamidopropylphosphonic acid); acrylic acid and methacrylic acid; and carboxyalkyl(meth)acrylates such as 2-carboxyethylacrylate, 2-carboxyethylmethacrylate, 3-carboxypropylacrylate, and 3-carboxypropylmethacrylate. Still other suitable acidic species include (meth)acryloylamino as described in U.S. Pat. No. 4,157,418 (Heilmann et al). Exemplary (meth)acryloylamino acids include, but are not limited to, N-acryloylglycine, N-acryloylaspartic acid, N-acryloyl-β-alanine, and 2-acrylamidoglycolic acid. Salts of any of these acidic species can also be used.

Other ionic graftable species that are capable of providing a positive charge are amino (meth)acrylates or amino (meth)acrylamides of Formula II or quaternary ammonium salts thereof. The counter ions of the quaternary ammonium salts are often halides, sulfates, phosphates, nitrates, and the like.

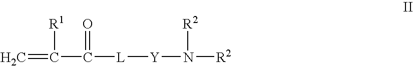

In Formula II, R¹ is hydrogen or methyl; L is oxy or —NH—; and Y is an alkylene (e.g., an alkylene having 1 to 10 carbon atoms, 1 to 6, or 1 to 4 carbon atoms). Each R² is independently hydrogen, alkyl, hydroxyalkyl (i.e., an alkyl substituted with a hydroxy), or aminoalkyl (i.e., an alkyl substituted with an amino). Alternatively, the two R² groups taken together with the nitrogen atom to which they are attached can form a heterocyclic group that is aromatic, partially unsaturated (i.e., unsaturated but not aromatic), or saturated, wherein the heterocyclic group can optionally be fused to a second ring that is aromatic (e.g., benzene), partially unsaturated (e.g., cyclohexene), or saturated (e.g., cyclohexane).

In some embodiments of Formula II, both R² groups are hydrogen. In other embodiments, one R² group is hydrogen and the other is an alkyl having 1 to 10, 1 to 6, or 1 to 4 carbon atoms. In still other embodiments, at least one of R² groups is a hydroxy alkyl or an amino alkyl that have 1 to 10, 1 to 6, or 1 to 4 carbon atoms with the hydroxy or amino group being positioned on any of the carbon atoms of the alkyl group. In yet other embodiments, the R² groups combine with the nitrogen atom to which they are attached to form a heterocyclic group. The heterocyclic group includes at least one nitrogen atom and can contain other heteroatoms such as oxygen or sulfur. Exemplary heterocyclic groups include, but are not limited to imidazolyl. The heterocyclic group can be fused to an additional ring such as a benzene, cyclohexene, or cyclohexane. Exemplary heterocyclic groups fused to an additional ring include, but are not limited to, benzoimidazolyl.

Exemplary amino (meth)acrylates (i.e., L in Formula II is oxy) include N,N-dialkylaminoalkyl(meth)acrylates such as, for example, N,N-dimethylaminoethylmethacrylate, N,N-dimethylaminoethylacrylate, N,N-diethylaminoethylmethacylate, N,N-diethylaminoethylacrylate, N,N-dimethylaminopropylmethacrylate, N,N-dimethylaminopropylacrylate, N-tert-butylaminopropylmethacrylate, N-tert-butylaminopropylacrylate and the like.

Exemplary amino (meth)acrylamides (i.e., L in Formula II is —NH—) include, for example, N-(3-aminopropyl)methacrylamide, N-(3-aminopropyl)acrylamide, N-[3-(dimethylamino)propyl]methacrylamide, N-(3-imidazolylpropyl)methacrylamide, N-(3-imidazolylpropyl)acrylamide, N-(2-imidazolylethyl)methacrylamide, N-(1,1-dimethyl-3-imidazoylpropyl)methacrylamide, N-(1,1-dimethyl-3-imidazoylpropyl)acrylamide, N-(3-benzoimidazolylpropyl)acrylamide, and N-(3-benzoimidazolylpropyl)methacrylamide.

Exemplary quaternary salts of the ionic species of Formula II include, but are not limited to, (meth)acrylamidoalkyltrimethylammonium salts (e.g., 3-methacrylamidopropyltrimethylammonium chloride and 3-acrylamidopropyltrimethylammonium chloride) and (meth)acryloxyalkyltrimethylammonium salts (e.g., 2-acryloxyethyltrimethylammonium chloride, 2-methacryloxyethyltrimethylammonium chloride, 3-methacryloxy-2-hydroxypropyltrimethylammonium chloride, 3-acryloxy-2-hydroxypropyltrimethylammonium chloride, and 2-acryloxyethyltrimethylammonium methyl sulfate).

Other graftable species can be selected from those known to provide positively charged groups, for example, to an ion exchange resin. Such graftable species include the dialkylaminoalkylamine adducts of alkenylazlactones (e.g., 2-(diethylamino)ethylamine, (2-aminoethyl)trimethylammonium chloride, and 3-(dimethylamino)propylamine adducts of vinyldimethylazlactone) and diallylamine species (e.g., diallylammonium chloride and diallyldimethylammonium chloride).

In some methods for making a functionalized membrane, suitable graftable species contain two free-radically polymerizable groups as well as a hydrophilic group. For example, alkylene glycol di(meth)acrylates can be used as graftable species to impart hydrophilic character to a hydrophobic porous base substrate. These graftable species have two (meth)acryloyl groups and a hydrophilic polyalkylene glycol (i.e., polyalkylene oxide) group.

When the functionalized membrane has grafted species that contains an epoxy group, an azlactone group, or an isocyanato group, the functionalized membrane can be further treated such that the functional groups can react with a nucleophilic compound having a one or a plurality of nucleophilic groups to impart a hydrophilic character to a hydrophobic porous base substrate. Unreacted nucleophilic groups can contribute to forming a hydrophilic functionalized membrane. Some exemplary nucleophilic compounds contain a hydrophilic group such as a polyalkylene oxide group in addition to the nucleophilic group. For example, the nucleophilic compound such as polyalkylene glycol diamines and polyalkylene glycol triamines can include a plurality of amino groups.

As described in further detail below, functionalized membranes of the present invention may be prepared using at least one graftable species or a mixture of two or more of the above-described graftable species to alter the surface properties of a porous substrate for making a functionalized membrane. When two or more of the above-described graftable species are used to alter the surface properties of the porous substrate, the species may be grafted onto the porous substrate in a single reaction step (i.e., the two or more graftable species are all present upon exposure to an electron beam) or in sequential reaction steps (i.e., a first graftable species is present upon a first exposure to an electron beam and a second graftable species is present upon a second exposure to the electron beam).

In applying graftable species to the porous substrate, at least one graftable species is applied to the porous substrate. In some embodiments, more than one graftable species can be applied to a porous substrate. In some cases, the graftable species may be part of a solution that contains other materials such as solvents. In other embodiments, the graftable species may be part of a dispersion, a suspension, an emulsion, or free of solvent (i.e., neat) or other materials. In some embodiments, graftable species can be applied sequentially to a porous substrate. At least one graftable species can be applied to a porous substrate and treated with electron beam radiation to provide for a first functionalized membrane. A second graftable species can then be applied to the first functionalized membrane and treated with electron beam radiation to provide for a second functionalized membrane. The second functionalized membrane can have additional surface properties or different surface properties than the first functionalized membrane.

In other embodiments, graftable species can be applied, treated with electron beam radiation and attached to the porous substrate for forming a first functionalized membrane having a gradient of grafted species. The concentration of grafted species can be greater at the first major surface than at the second major surface of the first functionalized membrane. The first functionalized membrane may then be coated with a second graftable species, and the membrane may be re-oriented and irradiated so that the second major surface of the first functionalized membrane receives a larger dose of electron beam radiation than the first major surface of the first functionalized membrane to provide a second functionalized membrane. The concentration of the second grafted species can be greater at the second major surface than at the first major surface of the second functionalized membrane.

Graftable species may first prepared as a coatable solution, dispersion, emulsion or the like which is applied to the first major surface, interstitial surfaces, and second major surface of the porous substrate. In some examples, the porous substrate is saturated or immersed in a solution of the graftable species to coat the first major surface, interstitial surfaces and the second major surface. The concentration of the graftable species, for example, in a solution may vary depending on a number of factors including, but not limited to, the graftable species in solution, the extent of grafting or attachment desired on the porous substrate, the reactivity of the graftable species, and the solvent used. In some embodiments, the concentration of the graftable species in a solution may be in a range of 0 weight percent to 100 weight percent, in a range of 5 weight percent to 60 weight percent, in a range of 5 weight percent to 40 weight percent, or in a range of 7 to 35 weight percent based on the total weight of the solution.

Some suitable application methods for applying or coating at least one graftable species to the porous substrate include, but are not limited to immersion, spray coating, flood coating, knife coating, or by other known coating or application methods.

In some embodiments, a functionalized membrane is formed using a multilayer structure wherein the porous substrate is coated with at least one graftable species as previously described to provide a coated porous substrate. A first layer is positioned adjacent to the first major surface of the coated porous substrate, and a second layer is positioned adjacent to the second major surface of the coated porous substrate to thereby form a multilayer structure. The first layer and the second layer may be discrete pieces of materials or they may comprise continuous sheets of materials. On a continuous process line, for example, the first layer and the second layer may be unwound from rolls and brought into contact with the coated porous substrate. In foregoing embodiments wherein the coated porous substrate is positioned (i.e., sandwiched) between a first layer and a second layer to form a multilayer structure, a single roller or multiple rollers may be used to meter or remove excess graftable species and entrapped air bubbles from the coated porous substrate. The first layer and the second layer of the multilayer structure may comprise any inert material that is capable of providing temporary protection to the functionalized membrane from exposure to oxygen upon exiting the electron beam chamber. Suitable materials for the first layer and the second layer include, but are not limited to, sheet materials selected from polyethylene terephthalate film material, other aromatic polymer film materials, and any other non-reactive polymer film material. Once assembled, the multilayer structure typically proceeds to irradiation. After irradiation by the electron beam source, the first layer and the second layer can be removed (i.e., eliminated) from the multilayer structure to provide a functionalized membrane.

The thickness of the first layer is generally in a range of 10 micrometers to 250 micrometers, 20 micrometers to 200 micrometers, 25 micrometers to 175 micrometers, or micrometers to 150 micrometers. The first layer and the second layer are generally inert materials, which include, but are not limited to materials such as poly(ethylene terephthalate). The second layer may have the same or a different thickness than that of the first layer. The first layer may be the same material or a different material that that used for the second layer.

In some embodiments, a first layer is positioned adjacent to the first major surface on the coated porous substrate to form a bilayer structure. The first layer is positioned between the electron beam source and the coated porous substrate. After irradiation by the electron beam source, the first layer can be removed (i.e., eliminated) from the bilayer structure to provide the functionalized membrane.

In another embodiment, the coated porous substrate is free of a first layer and a second layer. The coated porous substrate may be subjected to an inert atmosphere (e.g., nitrogen, argon) to reduce the penetration of oxygen to the coated porous substrate.

The coated porous substrate is exposed to electron beam radiation to form a functionalized membrane. Irradiation of the coated porous substrate allows for grafting or attachment of the at least one graftable species onto the surfaces of the porous substrate. The graftable species are referred to as grafted species after attachment to the surfaces of the coated porous substrate.

Suitable electron beam sources are known and are commercially available. In such devices, electron beams (e-beams) are generally produced by applying high voltage to tungsten wire filaments retained between a repeller plate and an extractor grid within a vacuum chamber maintained at about 10⁻⁶ Torr. The filaments are heated at a high current to produce electrons. The electrons are guided and accelerated by a repeller plate and an extractor grid towards a thin window of metal foil. The accelerated electrons, traveling at speeds in excess of 10⁷ meters/second (m/sec) and possessing about 10 to 300 kiloelectronvolts (keV) pass out of the vacuum chamber through the foil window and penetrate whatever material is positioned immediately beyond the foil window.

The quantity of electrons generated is directly related to the extractor grid voltage. As the extractor grid voltage is increased, the quantities of electrons drawn from the tungsten wire filaments increase. Electron beam (E-beam) processing can be extremely precise when under computer control, such that an exact dose of radiation and dose rate of electrons can be directed against materials.

Electron beam generators are commercially available from a variety of sources, including the ESI “ELECTROCURE” EB SYSTEM from Energy Sciences, Inc. of Wilmington, Mass., and the BROADBEAM EB PROCESSOR from PCT Engineered Systems, LLC of Davenport, Iowa. For any given piece of equipment and irradiation sample location, the dosage delivered can be measured in accordance with ASTM E-1275 entitled “Practice for Use of a Radiochromic Film Dosimetry System.” By altering the extractor grid voltage, beam area coverage and/or distance to the source, various dose rates can be obtained.

The temperature within the processing area is desirably maintained at an ambient temperature by conventional means. Without intending to be limited to any particular mechanism, it is believed that the exposure of the porous base substrate to an electron beam results in free radical initiation on the substrate which can then react with species having a double bond such as species having ethylenically unsaturated groups.

Electron beam radiation can be limited to certain thicknesses or depths within a material (i.e., porous substrate). The dose of radiation can be controlled (energy deposited per unit mass) to particular depths or thicknesses of an irradiated porous substrate. The energy delivered by an electron beam source may be adjusted by changing the voltage and current levels in order to deliver a selected amount of energy to a location and depth of a porous substrate. A window is provided between the electron beam source and the porous substrate to be irradiated. Commercial electron beam equipment includes a window positioned between the vacuum chamber where the electron beam is generated, and the atmosphere where the target materials (e.g., porous substrate) are irradiated. The window spreads out the electron beam via electron scattering. The window generally is made of titanium. The window typically has a unit path length of 3 to 60 grams per m² (meter²). A gap exists between the window and the material. The gap is generally filled with an inert gas such as nitrogen, argon, helium, or combinations thereof to reduce the presence of oxygen. The gap thickness between the window and the porous substrate is generally in the range of 0 g/m² to 200 g/m², 10 g/m² to 175 g/m², 25 g/m² to 150 g/m², or 50 g/m² to 125 g/m².

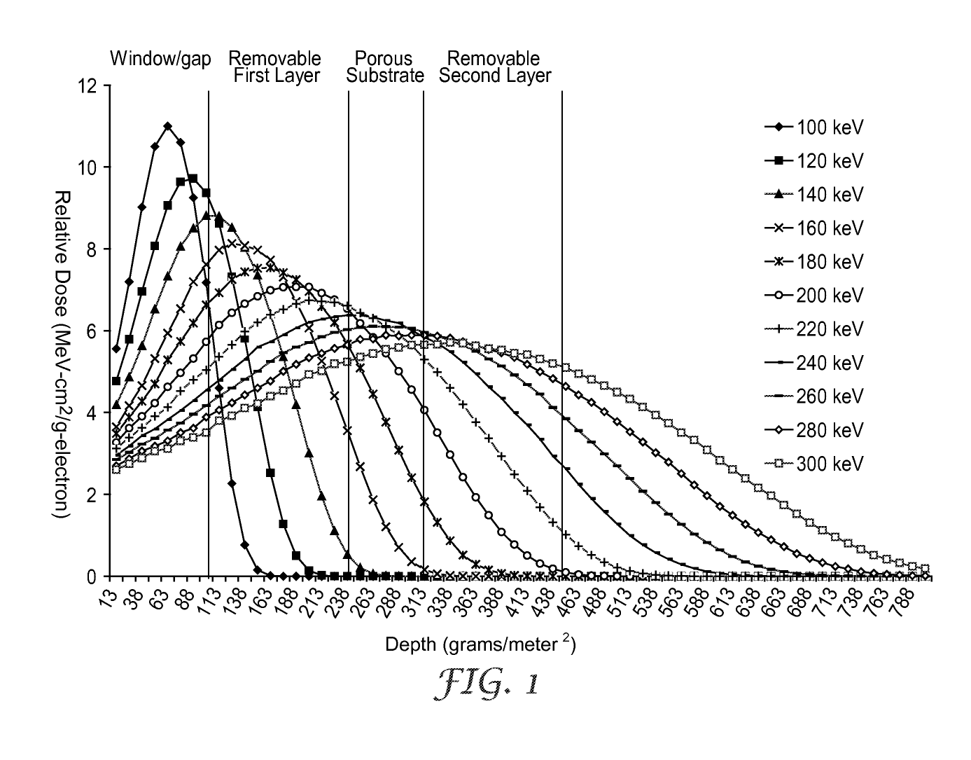

A dose profile, or gradient profile of electron beam radiation delivered through a cross-section of a coated porous substrate can be determined by plotting the electron beam dose at each increment of distance away from the electron beam source against the unit path lengths of each material the electron beam traverses. A graph of a dose profile is illustrated in FIG. 1.

A dose profile reaches a maximum, or peak, dose at some distance away from the electron beam source, then decreases with increasing path length. For example, a conventional titanium window having a nominal thickness of about 12 micrometers and a unit path length of 54 gsm (grams per square meter) absorbs enough energy such that the peak of a depth/dose curve of FIG. 1 does not move beyond the window/gap regions unless the voltage is increased to above 160 kV. The relative dose of electron beam radiation (calculated values based on Monte Carle code) in FIG. 1 is displayed in units of MeV-cm²/g-electron, which is characterized as a unit of dose per electron as described in ASTM Standard E2232-02 (Appendix A5), “Standard Guide for Selection and Use of Mathematical Methods for Calculating Absorbed Dose in Radiation Processing Applications.” The higher voltage typically creates a depth/dose profile that is flat and wide and slowly decreases through the irradiated material. The selection of a voltage to deliver a radiation dose to a coated porous substrate may be balanced to form a gradient of grafted species through the thickness of the coated porous substrate. Table 1 illustrates the dose of electron beam radiation delivered at an applied voltage to a coated porous substrate having a first layer using Monte Carlo code. The first layer is positioned between the window/gap and the first major surface of the coated porous substrate. As the thickness of the coated porous substrate decreases, the second major surface at a given voltage is exposes to a higher dose of electron beam radiation. As the voltage decreases, the dose of radiation at the second major surface of the coated porous substrate decreases.

TABLE 1
(Relative dose (kGy) delivered at an applied voltage)

| | | | Coated Porous | Coated Porous |
|---|---|---|---|---|
| | | | Substrate (2^{nd} | Substrate (2^{nd} |
| | First Layer | | major surface) | major surface) |
| | (thickness = | Coated Porous | (thickness = | (thickness = |
| Volts | 100 | Substrate (1^{st} | 63 | 100 |
| (kV) | micrometers) | major surface) | micrometers) | micrometers) |
| 140 | 167 | 40 | 0 | 0 |
| 150 | 140 | 40 | 0 | 0 |
| 160 | 120 | 40 | 0 | 0 |
| 170 | 84 | 40 | 10 | 4 |
| 180 | 62 | 40 | 18 | 9 |
| 190 | 50 | 40 | 22 | 12 |
| 200 | 40 | 40 | 27 | 14 |
| 300 | 29 | 40 | 42 | 41 |

Monte Carlo code may be effectively used to simulate depth/dose profiles useful for predicting the effects of various operating conditions on material being irradiated. These predictions allow for anticipating and adjusting the electron beam dose at various depths in the irradiated coated porous substrate, and allows for the optimal dosage needed to attach the graftable species onto the surface of the coated porous substrate. Suitable Monte Carlo codes include Integrated Tiger Series (ITS), Electron Gamma Shower EGS), and Monte Carlo Neutron-Proton (MCNP). Monte Carlo code makes it possible to identify an advantageous relationship between dosage and depth. The use of Monte Carlo code and related calculations are described in Weiss, D. E. et al., “Low-Voltage Electron-Beam Simulation Using the Integrated Tiger Series Monte Carlo Code and Calibration Through Radiochromic Dosimetry”, Irradiation of Polymers, ACS Symposium Series No. 620, Ch. 8, American Chemical Society, (1996) and in U.S. Pat. No. 6,749,903 (Weiss et al.). Another method used for calculating dose/depth profiles can be found in U.S. Pat. No. 5,266,400 (Yarusso et al.).

As illustrated in FIG. 1, a voltage of about 160 keV can deliver a gradient dose of radiation to the coated porous substrate. As illustrated in FIG. 1, the dose can range from about 4 MeV-cm²/g-electron to 0 MeV-cm²/g-electron through the thickness of the coated porous substrate. The dose can be adjusted in relation to the current. The gradient dose of radiation can provide for attaching a gradient of grafted species through the thickness of the coated porous substrate extending from the first major surface to the second major surface.

In one embodiment, the electron beam source energy (e.g., dose or delivered dose of energy) to the coated porous substrate is generally between 10 kGy to 200 kGy, 12 kGy to 150 kGy, 14 kGy to 125 kGy, 15 kGy to 100 kGy, or 16 kGy to 50 kGy. The electron beam voltage and the current can be adjusted. As the gap increases, the electron beam energy decreases and a certain gradient of voltage to be delivered can be achieved by increasing the voltage. The voltage can be generally in a range of 80 keV (kiloelectronvolts) to 300 keV, 100 keV to 275 keV, 125 keV to 250 keV, 130 keV to 225 keV, or 140 keV to 200 keV to deliver a gradient dose of radiation to a coated porous substrate. The gap thickness between the window and the coated porous substrate can be adjusted for the electron beam to modify a radiation modifiable material. In some embodiments, the gap thickness between the window and a first layer positioned between the window and the coated porous substrate can be adjusted for the electron beam. In some embodiments, more than one electron beam source, or multiple exposures to electron beam radiation may be used to effect a gradient of radiation through a coated porous substrate.

The coated porous substrate can have a thickness in the range of 25 micrometers to 750 micrometers. In some embodiments, the coated porous substrate has a thickness in a range of 50 micrometers to 650 micrometers, 50 micrometers to 550 micrometers, 75 micrometers to 450 micrometers, 100 micrometers to 350 micrometers, or 100 micrometers to 300 micrometers.

When introducing a gradient of radiation through the thickness of a coated porous substrate, the dose of radiation decreases as the distance from the window to the coated porous substrate increases. The dose of radiation also decreases through the thickness of the coated porous substrate as the thickness of the coated porous substrate increases. The coated porous substrate when exposed to a dose of radiation receives the largest dose (i.e., concentration) of radiation at a first major surface. The dose of radiation gradually decreases through the thickness of the coated porous substrate as the distance from the electron beam source increases. The gradient of radiation extends from the first major surface (i.e., surface closest to the radiation source) to the second major surface (i.e., surface furthest from the radiation source). In some embodiments, the gradient of radiation may decrease to zero before reaching the second major surface of the coated porous substrate.

The dose of electron beam radiation received by a coated porous substrate primarily affects the extent to which the at least one graftable species is grafted at the first major surface and the formation of a gradient of grafted species distributed through the thickness of the coated porous substrate extending to the second major surface. In some embodiments of this disclosure, it is typical to convert at least 10 weight percent, at least 20 weight percent, or at least 50 weight percent of the graftable species of the coated porous substrate to grafted species. Further, it is typical to attach as much as about 5 weight percent, as much as 10 weight percent, as much as 20 weight percent, and as much as 30 weight percent of the graftable species added during application to the porous substrate based on a total weight of the porous substrate to form grafted species.

The dose of radiation delivered to the coated porous substrate is dependent upon, but not limited to, processing parameters including voltage, line speed (i.e., continuous process line) and the electron beam current. The dose of radiation can be regulated by controlling line speed, and the current supplied to the extractor grid of the electron beam source. For example, a target dose of 20 kGy delivered to a coated porous substrate can be calculated by multiplying an experimentally measured coefficient (i.e., a machine constant) by the electron beam current and dividing by the web speed to determine the exposure. The machine constant varies as a function of electron beam voltage.

The dose of electron beam radiation delivered to a coated porous substrate can be dependent upon the residence time. The attachment or extent of attachment of the graftable species to the coated porous substrate can be controlled by the dose of radiation and can effect the concentration of grafted species distributed through the thickness of the coated porous substrate. The dose delivered through the thickness of the coated porous substrate can be in a range of 0 to 200 kGy. While low dose rates and longer residence times are preferred for radiation, attachment of graftable species for practical operation may necessitate speeds that force higher dose rates and shorter residence times. For example, the exclusion of oxygen in a multilayer structure (e.g., the coated porous substrate being positioned between a first layer and a second layer) as an alternative to excluding oxygen from the entire web path and winders can allow for free radical chemistry to continue after exposure to the electron beam for a duration sufficient to improve the grafting or attachment yield for forming a functionalized membrane. The selected voltage to produce a gradient of radiation may be dependent on the window unit path length, the gap thickness, the material used for the first layer, the thickness of the first layer, the material used for the porous substrate, and the thickness of the coated porous substrate and combinations thereof.

In some embodiments, the porous substrate may be treated with electron beam radiation prior to the application of the graftable species. After irradiation of the porous substrate, the porous substrate may have a graftable species applied to the porous substrate under an inert atmosphere to form a functionalized membrane.

The penetration of electron beam radiation can be limited or attenuated through the coated porous substrate to produce a gradient of grafted species on functionalized membranes that have different compositions on one side than the other. In one embodiment, the functionalized membrane is an asymmetric membrane having a hydrophilic surface and a hydrophobic surface.

The functionalized membrane can have a variety of surface properties and structural characteristics depending on a number of factors. These factors include without limitation the physical and chemical properties of the porous substrate, the geometry of the pores of the porous substrate (i.e., symmetric or asymmetric), the method of forming the porous substrate, the species grafted onto the surfaces (i.e., first major, interstitial, and second major) of the coated porous substrate, optional post-graftable treatments (e.g., a heating step) administered to the functionalized membrane, and optional post-graftable reactions (e.g., reactions of the additional functional group of the grafted species with a compound such as a nucleophilic compound or a compound with an ionic group).

Functionalized membranes can exhibit various degrees of wettability upon exposure to various solutions or solvents. Wettability can often be correlated to the hydrophilic or hydrophobic character of the functionalized membrane. As used herein, the term “instant wet” or “instant wettability” refers to the penetration of droplets of water into a given functionalized membrane as soon as the water contacts the porous substrate surface, typically within less than 1 second. For example, a surface wetting energy of about 72 dynes or larger usually results in instant wetting. As used herein, the term “no instant wet” refers to penetration of droplets of water into a given substrate but not as soon as the water contacts the substrate surface. As used herein, the term “no wetting” refers to the lack of penetration of droplets of water into a given functionalized membrane. For example, a surface wetting energy of about 60 dynes or less usually results in no wetting.

Application of graftable species onto a hydrophobic porous substrate and treating the coated hydrophobic porous substrate to electron beam radiation can result in a membrane having first and second major surfaces having hydrophobic character, a first major surface having hydrophilic character and a second major surface having hydrophobic character, or first and second major surfaces having hydrophilic character. Similarly, applying graftable species onto a hydrophilic porous substrate and treating the coated hydrophilic porous substrate to electron beam radiation can result in a functionalized membrane having first and second major surfaces having hydrophilic character, a first major surface having hydrophobic character and a second major surface having hydrophilic character, or first and second major surfaces having hydrophobic character.

The present disclosure also provides functionalized membranes comprising a first major surface, interstitial surfaces and a second major surface, and a gradient of grafted species attached to a porous substrate such that the concentration of grafted species is greater at the first major surface than at the second major surface. The functionalized membrane comprises a gradient of grafted species extending through the thickness of the functionalized membrane from the first major surface to the second major surface. The functionalized membrane can have a particular surface property at one major surface and a different surface property at another major surface. In some embodiments, an asymmetric membrane having a first major surface with larger pore sizes than the pores of the second major surface can be used for forming functionalized membranes. In some embodiments, attachment of grafted species can occur at the first major surface of the asymmetric membrane such that the concentration of grafted species is greater at the first major surface than at the second major surface. In some embodiments, attachment of grafted species can occur at the second major surface of the asymmetric membrane such that the concentration of grafted species is greater at the second major surface than at the first major surface.

Symmetric membranes uniformly coated with graftable species can form functionalized asymmetric membranes having a gradient of grafted species. The functionalized membranes described herein contain a porous substrate having functionalized surfaces which can provide for functionalized membranes having hydrophilic properties, hydrophobic properties, or a combination of hydrophilic and hydrophobic properties. These functionalized membranes can, in some examples, have a gradient of charge affinity properties extending through at least a portion of the membrane for capture or ion exchange capabilities. In some embodiments, the functionality of the functionalized membranes can be altered to account for physical size exclusion or molecular weight cut off properties.

Asymmetric membranes formed through phase separation or other methods useful for forming membranes described herein can also be functionalized with a gradient of grafted species. The gradient of grafted species is such that the concentration of grafted species can be greater at a first major surface and the concentration of grafted species can decrease extending through the membrane to the second major surface. In some embodiments, the gradient of grafted species can be greater at a second major surface and the concentration of grafted species can decrease toward the first major surface. In some embodiments, the functionalized membrane comprises an asymmetric porous substrate such that the first major surface has an average pore size diameter that is greater than the average pore diameter of the second major surface. In some embodiments, the average pore diameter of the first major surface is less than the average pore diameter of the second major surface.

Functionalized asymmetric membrane or symmetric membranes rendered asymmetric by the method of the present disclosure can have applications that include, but are not limited to water softening, filtration, and chromatography. In some embodiments, a functionalized asymmetric membrane with sterilization grade membrane performance can be formed. This membrane can have a charged gradient of grafted species starting at the first major surface with a larger pore size (e.g., diameter) than the second major surface such that the first major surface faces the feedstock. The upper portion starting at the first major surface of the functionalized asymmetric membrane can function as a pre-filter having affinity and size exclusion filtration properties which can provide for longer throughput life, and the smaller pore diameters extending through the thickness of the membrane toward the second major surface can provide size exclusion properties with minimal flux reduction. The smaller pore diameters of the membrane can regulate flux and the gradient of grafted species can be such that the concentration of grafted species is small or zero at the second major surface. The functionalized asymmetric membrane described here can, for example, provide for capture and storage of contaminants in the larger diameter pores with less fouling of the smaller diameter pores occurring.

In some embodiments, the functionalized asymmetric substrate can have a greater concentration of grafted species at the first major surface such that the average pore diameters are smaller than the average pore diameters of the second major surface. The gradient of grafted species can extend from the first major surface to a location within the membrane or to the second major surface. The larger concentration of grafted species at the first major surface can provide for an ultra or nano-filtration membrane for normal flow filtration or tangential flow filtration. The smaller pore diameters can provide for easier constriction of the pores.

In one embodiment, the porous substrate is hydrophobic or hydrophilic. In another embodiment, a functionalized asymmetric membrane comprises a hydrophobic surface and a hydrophilic surface. A first major surface can be hydrophilic and a second major surface can be hydrophobic.

In one embodiment, a functionalized membrane comprises a symmetric porous substrate. The functionalized symmetric membrane comprises a gradient of grafted species extending from the first major surface to the second major surface, such that the concentration of grafted species is greater at the first major surface than at the second major surface. In another embodiment, a first major surface is hydrophilic and a second major surface is hydrophobic.

In another embodiment, a functionalized membrane comprises an asymmetric porous substrate. The functionalized asymmetric membrane comprises a gradient of grafted species extending from the first major surface to the second major surface, such that the concentration of grafted species is greater at the first major surface than at the second major surface. In another embodiment, a first major surface is hydrophilic and a second major surface is hydrophobic.

The functionalized membranes of the present disclosure can be used in any of a variety of applications including use in fuel cell and related applications. Membranes used in these applications generally need moisture vapor transmission without air flow. The flow of moisture vapor (e.g., moisture vapor transmission (MVT)) into fuel cells allows for such cells to remain hydrated without gas (air) crossover when a cell is dehydrated at start up conditions.

Keeping fuel cells hydrated is important without allowing gas (air) crossover in a fuel cell if the cell is completely dehydrated at start up conditions. Examples of functionalized asymmetric membranes of this disclosure provide for restricted air flow, but allow for moisture vapor transmission (MVT). The flow of air through an asymmetric functionalized can be measured using Gurley porosity measurements. These measurements measure the time in seconds for 50 cubic centimeters (cc) of air or another volume to pass through one square inch or 6.35 cm² of a functionalized membrane at a pressure of 124 mm water. An unrestricted air flow can be represented by air quickly passing through a functionalized membrane. In one embodiment, a functionalized membrane having a hydrophobic surface and a hydrophilic surface can have a Gurley porosity of greater than 20 minutes and a MVT of approximately 87 percent of an unmodified porous substrate.

The disclosure will be further clarified by the following examples which are exemplary and not intended to limit the scope of the disclosure.

### EXAMPLES

Unless otherwise noted, all parts, percentages, and ratios reported in the following examples are on a weight basis, and all reagents used in the examples were obtained, or are available, from the chemical suppliers described below, or may be synthesized by conventional techniques.

### Test Methods

### Fluid Flux Measurements

Fluid flux measurements (e.g., water, solvents) were determined by placing a disk of the membrane having a diameter of approximately 47 millimeters (mm) (1.85 inches) in a Model 4238 Pall Gelman magnetic filter holder having an effective filtration diameter of 41 mm available from Pall Corporation of East Hills, N.Y. The filter holder was then placed on a filter flask that was attached to a vacuum pump. A vacuum gauge was used to monitor the vacuum. Approximately 150 milliliters (ml) of water or fluid was placed in the filter holder and then vacuum was applied. After approximately 50 ml of water or fluid passed through the membrane (the vacuum gauge at this time indicated approximately 533 mm of mercury (˜21 inches of mercury (Hg)), timing was commenced using a stopwatch. When all of the remaining water or fluid had passed through the membrane, timing was stopped. The fluid flux was calculated from the time, measured in seconds, which elapsed for 100 ml of water or fluid to pass through the membrane.

### Flux Pressure Measurements

Flux pressure measurements (e.g., water, solvents) were determined by placing a membrane having a diameter of approximately 37 millimeters (mm) (1.85 inches) in a Model 2220 Pall Gelman filter holder available from Pall Corporation of East hills, N.Y. The membrane was loaded into the filter holder with the first major surface facing up (greater concentration of grafted species) towards the inlet stream. Flux pressure measurements were conducted using a Dead-End Filtration System designated under the trade designation FilterTek available from Scilog Incorporated of Middleton, Wis. The filtration equipment was run in a constant pressure mode and varied over a range of 10-70 psi. The flow rate was recorded in milliliters/minute.

### Average Pore Diameter

The average pore diameter of the membrane was determined by allowing a wetting liquid to spontaneously fill the pores in the membrane and then using a non-reacting gas to displace the liquid from the pores of the membrane. The gas pressure and flow rates are accurately measured using an Automated Capillary Flow Porometer (model no. APP-1200-AEX) with supplied software (CAPWIN Version 6.71.54) obtained from Porous Materials Incorporated (PMI) of Ithaca, N.Y. A wetting fluid obtained from 3M Corporation of St. Paul, Minn., under the trade designation FLUORINERT FC-43, was used as the wetting fluid and compressed nitrogen gas was used for displacement with a maximum pressure setting of 689.5 kilonewtons/(meter) (kN/m²) (100 pounds per square inch (psi)). The tests were run in the wet up/dry down software configuration.

### Comparative Example 1 and Example 2

A nylon membrane (i.e. porous substrate) obtained from 3M CUNO of Meriden, Conn., under the trade designation F150AOA, was coated with a solution containing 12.5 weight percent (wt. %) sodium 2-acrylamido-2-methyl-1-propanesulfonate (AMPS; concentration of 50-60 wt. % in water as received) monomer (i.e., graftable species) obtained from Lubrizol Corporation of Wicliffe, Ohio and 87.5 wt. % (weight percent) DI water. The porous substrate was immersed in the solution to wet the first major surface, interstitial surfaces and the second major surface. Comparative Example 1 was the same porous substrate above, but not immersed in the solution. The coated porous substrate of Example 2 was then positioned ‘wet’ between two layers (first and second) of PET (polyethylene terephthalate) film having a thickness of 100 micrometers to form a multilayer structure. The excess solution was squeezed out and the trapped air bubbles were removed form the multilayer structure by applying a rubber roller over the surface of the multilayer structure. The multilayer structure was taped to a moving web of PET and conveyed through the electron beam processor at a speed of 6.1 meters per minute (mpm). The multilayer structure was irradiated by an electron beam source (E-beam) on an ESI CB-300 electron beam system obtained from Energy Sciences, Inc. of Wilmington, Mass. The electron beam processor was set at an accelerating voltage of 170 keV with sufficient electron beam current applied to the cathode to deliver a dose of 60 kGy in a single pass at the conveying speed of 6.1 mpm. The electron beam was calibrated using thin film dosimeters, calibrated and traceable to a national standards laboratory (RISO of Denmark). The dose delivered herein refers to the surface dose (e.g., dose delivered to the first layer of PET of the multilayer structure) recorded with a dosimeter.

After irradiation, the multilayer structure was removed from the moving web and allowed to stand for about two minutes before being opened. The grafted species attached to the coated porous substrate forming a functionalized membrane between the removable first and second layers. The functionalized membrane was removed from the first and second PET layers. The functionalized membrane was soaked in a tray of water that was exchanged three times with DI water to wash the functionalized membrane of unreacted graftable species. The functionalized membrane was blotted dry with paper towels and allowed to air dry. Residual graftable species that are not easily removed with water may be extracted from the functionalized membrane by washing with methyl ethyl ketone (MEK), alcohol, or other suitable solvents.

The average pore size of the porous substrate of Comparative Example 1 was measured to be 1.18 micrometers, and the functionalized membrane of Example 2 had an average pore size of 1.27 micrometers (μm) indicating that little or no pore plugging occurred from the grafted species attached to the surfaces of the porous substrate. The average pore diameters of Comparative Examples 1 and Example 2 were determined by the average pore diameter method described earlier.

The influence of solvent (e.g., fluid) on the pores of the functionalized membrane was investigated using fluid flux measurements recorded in Table 2. The water flux measurements for Comparative Example 1 and Example 2 are shown to be very different with Comparative Example 1 being greater than for Example 2, yet the porosity and average pore size diameters for Example 2 and Comparative Example 1 were similar. This difference can be explained by concluding the Fluorinert FC-43 wetting fluid used in the average pore size measurements does not swell the grafted species of the membrane and the grafted species do not block the pores of Example 2. Fluid flux measurement of Comparative Example 1 and Example 2 with MEK were greatest as a result of less swelling of the membrane pores and the grafted species of Example 2 suggesting larger average pore diameters. Isopropyl alcohol (IPA) can swell the membranes but not the grafted species in Example 2 since both of the membranes have similar reduced flux values as compared to the MEK flux values. Both membranes have reduced water flux values as compared to the MEK flux but more with Example 2. Additional restriction in flux can be attributed to the swelled grafted species of the pores in the presence of water to the upper gradient of the asymmetric graft from the AMPS monomer. Small pores are more easily prone to plugging and flux reductions using grafted species that swell. Graft control of the grafted species that can swell can contribute to maintaining the inherent flux properties of the porous substrate. The swelling phenomenon makes membranes with small pores especially vulnerable to flux reductions.

TABLE 2
Fluid Flux (L/(m²-hr-psi))

| | Average Pore | | | |
|---|---|---|---|---|
| | Diameter (μm) | Water | IPA | MEK |
| Comparative | 1.18 | 1,621 | 777 | 3,435 |
| Example 1 | | | | |
| Example 2 | 1.27 | 153 | 672 | 3,937 |

### Examples 3 and 4

Two 47 mm disks from the functionalized membrane formed in Example 2 were cut out and placed in two 20 milliliter (ml) vials containing a charged dye (positive or negative) having a concentration of 0.0016 M (molar) in water. A negative charged dye obtained from Alfa Aesar of Heysham, Lancashire England under the trade designation METANIL YELLOW was used for Example 3. A positive charged dye obtained from Sigma-Aldrich of St. Louis, Mo. under the trade designation ASTRAZON ORANGE G was used for Example 4. The vials containing the functionalized membranes of Examples 3-4 were spun with a Vortex mixer for 15 seconds. The functionalized membranes were removed from the vials, and rinsed with deionized (DI) water. The functionalized membranes were flushed with DI water by mounting each of the functionalized membranes in a 47 millimeter (mm) Gelman Magnetic Filter Funnel (model number 4238) available from Pall Corporation of Ann Arbor, Mich. About 400 ml of DI water was drawn at 530 mmHg vacuum (10 psi) through the functionalized membranes and then the functionalized membranes were subsequently dried. Side A of the functionalized membrane represents the first major surface and Side B represents the second major surface of the functionalized membrane. Table 3 lists the results of Examples 3-4.

TABLE 3

| | | | | Side A (first | Side B (second |
|---|---|---|---|---|---|
| | | Graftable | | major surface) | major surface) |
| | Porous | Species | Dye charge | dye binding (yes | dye binding (yes |
| Example | Substrate | (charge) | (+)/(−) | or no/color | or no)/color |
| 3 | Nylon | AMPS (−) | METANIL | no/none | yes/yellow |
| | | | YELLOW | | |
| | | | (−) | | |
| 4 | Nylon | AMPS (−) | ASTRAGON | yes/orange | no/none |
| | | | ORANGE G | | |
| | | | (+) | | |

Example 3 showed an affinity for the Metanil Yellow dye of the functionalized membrane at Side B resulting in a strong yellow color such that the nylon substrate having a slight positive charge attracted the negatively charged dye. The yellow dye was washed from Side A having a higher concentration of grafted species possessing a negative charge (AMPS) more so than at Side B indicative of a functionalized asymmetric membrane. Example 4 showed an affinity for the orange dye to the functionalized asymmetric membrane at Side A (high concentration of grafted species (AMPS) having negatively charged surface attracting the positively charged dye). The orange dye has little or no affinity for Side B having little or no grafted species indicative of a functionalized asymmetric membrane. Side A had an intense orange color.

A cross-section of the functionalized membrane of Example 3 showed a greater concentration of the yellow dye bound at Side B, and little or no binding of the yellow dye to Side A. The intensity of the yellow dye was greatest at Side B and the color intensity decreased across the thickness to Side A of Example 3.

A cross-section of the functionalized membrane of Example 4 showed a greater concentration of the orange dye bound to Side A and little or no binding of the orange dye to Side B. The intensity of the orange dye was greatest at Side A and the color intensity decreased across the thickness to Side B of Example 4.

### Examples 5 through 20

A PVDF membrane (i.e. porous substrate) was made by a process described in U.S. Patent Publication No. 2005/0058821 (Smith et al.). The porous substrate had an average pore size of about 0.7 micrometers. The porous substrate was coated with a solution having (3-acrylamidopropyl) trimethylammonium chloride (APTAC) monomer (i.e., graftable species) obtained from TCI Tokyo Kasei of Japan under the trade designation A1493, PEG 400 diacrylate (DIAC) obtained from Sartomer Company Incorporate of Exton, Pa. under the trade designation SR-344, and methanol (MeOH) obtained from Sigma Aldrich of St. Louis, Mo. The APTAC monomer as obtained had a concentration of 74-76 wt. % in water. After the porous substrate was coated with the solution, it was placed ‘wet’ between two layers of PET film (removable first and second layers) having a thickness of approximately 100 micrometers each. The first layer and the second layer were each placed on opposing sides of the coated porous substrate with excess solution and trapped air bubbles squeezed out with a hand held rubber roller. The multilayer structure was conveyed through the electron beam on a carrier web. The multilayer structure was irradiated by electron beam (E-beam) on an ESI CB-300 electron beam system with a dose ranging from 30 kGy to 100 kGy. The electron beam operated at voltages ranging from 140 keV to 300 keV. Two minutes following irradiation, the functionalized membrane was removed from the first and second PET layers. The functionalized membrane was soaked in a tray of water that was exchanged three times with DI water to wash the functionalized membrane of unreacted graftable species and subsequently air dried. Examples 5-20 are listed in Table 4.

TABLE 4

| | | | | | Fluid Flux | | |
|---|---|---|---|---|---|---|---|
| | | DIAC/ | PEG | MeOH/ | (Water) | Salt | Dye Binding/ |
| | E-beam | APTAC | 200 | H₂O | (L/(m²-hr- | Rejection | Solution |
| Example | (kGy/keV) | (wt. %) | (wt. %) | (wt. %) | psi)) | (%) | Color |
| 5 | 40/160 | 10/20 | — | 63.3/ | 16.1 | — | Yes/Clear |
| | | | | 6.7 | | | |
| 6 | 40/150 | 10/20 | — | 63.3/ | 6.7 | — | No/Orange |
| | | | | 6.7 | | | |
| 7 | 30/160 | 10/20 | — | 63.3/ | 2.1 | — | Partial/Light |
| | | | | 6.7 | | | Yellow |
| 8 | 40/300 | 10/20 | — | 63.3/ | 0 | — | — |
| | | | | 6.7 | | | |
| 9 | 60/150 | 10/20 | — | 63.3/ | 4.8 | — | No/Orange |
| | | | | 6.7 | | | |
| 10 | 60/150 | 10/20 | — | 63.3/ | 10.0 | — | No/Orange |
| | | | | 6.7 | | | |
| 11 | 40/160 | 10/10 | — | 76.7/ | 0.5 | 50% | No/Orange |
| | | | | 3.3 | | | |
| 12 | 40/180 | 10/10 | — | 76.7/ | 0.2 | 36% | — |
| | | | | 3.3 | | | |
| 13 | 40/300 | 10/10 | — | 76.7/ | 0 | — | — |
| | | | | 3.3 | | | |
| 14 | 40/300 | 2.5/10 | — | 84.2/ | fast | — | No/Orange |
| | | | | 3.3 | | | |
| 15 | 60/160 | 10/20 | — | 63.3/ | 0 | — | Yes/Clear |
| | | | | 6.7 | | | |
| 16 | 40/150 | 7/24 | — | 61.0/ | 1) 0.5 | — | No/Yellow |
| | | | | 8.0 | 2) 47 (dried, | | No/Yellow |
| | | | | | rewet) | | |
| 17 | 60/150 | 7/24 | — | 61.0/ | 1) 0.1 | — | Yes/Clear |
| | | | | 8.0 | 2) >50 (dried, | | Yes/Clear |
| | | | | | rewet) | | |
| 18 | 40/150 | 7/24 | — | 61.0/ | 0.23 | 26% | Yes/Clear |
| | | | | 8.0 | | | |
| 19 | 40/150 | 7/24 | 20 | 41.0/ | 8.6 | — | Yes/Nearly |
| | | | | 8.0 | | | Clear |
| 20 | 40/180 | 10/20 | — | 63.3/ | 2.0 | — | Yes/Nearly |
| | | | | 6.7 | | | Clear |

Example 9 was the same functionalized membrane as used in Example 10, but with the first major surface facing upstream in contrast to Example 10. Example 10 was flipped over in the holder for the fluid flux measurements. The surface with the highest concentration of grafted species (i.e. gelled side) was facing downstream. The gelled surface was not washed away.

Examples 16 and 17 showed fluid flux measurements for functionalized membranes without drying (1). Fluid flux measurements were made after drying and rewetting (2) showed increased fluid flux.

Example 19 contained PEG 200 was obtained from the Dow Chemical Company of Midland, Mich. under the trade designation POLYGLYCOL E200 as a porogen for forming pores within the coated porous substrate.

Salt Rejection (%) for Examples 11-12 and 18 shown in Table 4 was determined by the water flux testing procedure with the following modifications. The DI water used for this method had about 2 grams of magnesium chloride (MgCl₂) added per liter of water. After the MgCl₂ was added, additional DI water was added to achieve a conductivity of about 1130 μs/cm as measured with a VWR Conductivity Meter (Model No. 61161-662) obtained from VWR of West Chester, Pa. A stirring mechanism was operated at 300 rpm. For Examples 11, 12 and 18, the first major surface (highest concentration of grafted species) was positioned face up in the holder. The measurement probe of the conductivity meter was placed in the effluent stream and the lowest conductivity measurement was recorded for the functionalized membranes. The percent salt rejection was determined with the following calculation:

1−(conductivity/1130 μs/cm)×100=Percent Salt Rejection.

Dye binding capacity of the functionalized membranes of Examples 5-20 were investigated with a positively charged grafted species as described above. Forty-seven mm disks of Examples 5-20 were formed and placed in 20 ml vials containing a negatively charged dye at a concentration of 0.0016M in water. The negative charged dye was obtained from Alfa Aesar of Heysham, Lancashire England under the trade designation METANIL YELLOW. The vials were gently rocked for 12 hours. An orange colored solution indicated that little or no dye was bound by the functionalized membrane. A clear colored solution indicated that all or nearly all of the dye was bound by the functionalized membrane. Light colored yellow or orange solutions indicated partial binding of the dye by the functionalized membranes as shown in Table 4.

### Example 21

A polyvinylidene fluoride (PVDF) porous substrate described in Examples 5-20 was used in Example 21. The porous substrate was coated with a solution (e.g., graftable species) containing 10.0 wt. % PEG 400 diacrylate monomer available from Sartomer Company Incorporate of Exton, Pa. under the trade designation SR-344 and 90.0 wt. % methanol (MeOH) obtained from Sigma Aldrich of St. Louis, Mo. The coated porous substrate was then placed ‘wet’ between two layers of PET film (first layer and second layer) having a thickness of approximately 100 micrometers with any excess solution and trapped air bubbles squeezed out with a hand held rubber roller. The multilayer structure was conveyed through the electron beam on a carrier web. The multilayer structure was irradiated by electron beam (E-beam) on an ESI CB-300 electron beam with a dose of 60 kGy set at a voltage of 170 keV. Two minutes following irradiation, the functionalized membrane was removed from the first and second PET layers. The membrane was soaked in a tray of water that was exchanged three times with DI water to wash the functionalized membrane of unreacted graftable species and subsequently air dried.

The functionalized membrane formed in Example 21 was immersed in water. Side A was closest to the electron beam radiation source during irradiation. Side B was opposite Side A of the functionalized membrane. The concentration of radiation was greater at Side A and a gradient of radiation was provided from Side A to Side B.

The functionalized asymmetric membrane of Example 21 contains a hydrophilic side (Side A) and a hydrophobic side (Side B). The concentration of grafted species was greater at Side A such that water fills the pores and Side A darkens or appears dark blue. Side B does not fill with water and Side B diffuses or scatters visible light resulting in a light blue color. The results of Example 21 are described in Table 5.

TABLE 5

| Side A/Color | Side B/Color |
|---|---|
| Hydrophilic/dark blue | Hydrophobic/light blue |

### Comparative Example 22 (CE 22) and Examples 23-26

### Moisture Vapor Transmission (MVT)

A PVDF porous substrate described in Example 21 was used for Comparative Example 22 and Examples 23-26 to evaluate MVT properties. A solution containing graftable species (containing 10.0 wt. % or 25 wt. % PEG 400 diacrylate monomer in DI water) was coated onto the porous substrate of Examples 23-26. Comparative Example 22 was not coated with the solution containing the graftable species. Examples 23-26 were irradiated with an electron beam source at the voltages presented in Table 6. In Examples 25-26, two passes (a) and b)) of electron beam radiation were used.

Moisture Vapor Transmission (MVT) studies were conducted on Comparative Example 22 and Examples 23-26 using ASTM E-96-80. The test method was modified by using a test chamber having a circulating air oven maintained at 60° C. and 35% relative humidity (% RH). A head space of 3.175 cm between the functionalized membrane and the level of the water in the vial was maintained. Bottles having a volume of about 67 ml having a 1.91 cm opening were used. The caps for the bottles were center drilled having an opening of 1.91 cm. The bottles were filled with about 50 ml of DI water. Samples for Comparative Examples 22 and Examples 23-26 were cut to about 2.54 cm in diameter and bonded to the rim of the bottles. The caps were secured to ensure no loss of water except through the functionalized membrane. The bottles were placed upright in a convection oven at 60° C. for 18 hours. The bottles were then removed from the oven and the contents weighed. The moisture vapor transmission of the membranes was calculated and recorded in Table 6.

Gurley air permeability was recorded to measure the resistance to gas flow through functionalized membrane as expressed as the time necessary for a given volume of gas (50 cm³) to pass through a standard area (6.35 cm³) of a functionalized membrane at a pressure of 124 mm of water as listed in Table 6. Gurley air permeability is further specified in ASTM D726-58, Method A.

TABLE 6

| | Graftable | | | | |
|---|---|---|---|---|---|
| | Species | | | | |
| | Concentration | Gurley air | | | |
| | (wt. %)/ | permeability | MVT | Hydrophilic/ | Resultant |
| Example | Voltage (keV) | (seconds/50 cm³) | (g/m²/24 hours) | Hydrophobic | Membrane |
| CE22 | None | 7.4 | 29,941 | Hydrophobic | Symmetric |
| 23 | 10/300 | 8.3 | 27,134 | Hydrophilic | Symmetric |
| 24 | 10/170 | 8.6 | 28,538 | Hydrophilic | Asymmetric |
| | | | | vapor side/ | |
| | | | | Hydrophobic | |
| 25 | a) 10/300 | 1,257 | 25,730 | Hydrophilic | Asymmetric |
| | b) 20/170 | | | | |
| 26 | a) 10/300 | >2,000 | 18,713 | Hydrophilic | Asymmetric |
| | b) 25/170 | | | | |

Examples 25 and 26 exhibited low air flow rates with MVT values relatively approximate to those of Comparative Example 22.

### Comparative Example 23

### CE23

An asymmetric nylon membrane (porous substrate) was obtained from 3M CUNO of Meriden, Conn., under the trade designation LifeAssure BLA-045. Comparative Example 23 (CE23) was a three zone membrane (multizone membrane) having average pore diameters of about 0.8 μm/0.8 μm/0.45 μm.

### Examples 27 and 28

Comparative Example 23 (CE23) was coated with a solution having 12.5 weight percent (wt. %) sodium 2-acrylamido-2-methyl-1-propanesulfonate (AMPS; concentration of 50-60 wt. % in water) monomer (e.g., graftable species) obtained from Lubrizol Corporation of Wicliffe, Ohio and 87.5 wt. % (weight percent) deionized (DI) water. The porous substrate was coated with the solution to wet the first major surface, interstitial surfaces and the second major surface. The coated porous substrate was then positioned with the large pore size up (first major surface) and sandwiched ‘wet’ between two layers (removable first and second layers) of PET (polyethylene terephthalate) film having a thickness of 100 micrometers each. The first layer and the second layers of PET were placed on opposing sides of the coated porous substrate to form a multilayer structure with the excess solution and trapped air bubbles squeezed out with a hand held rubber roller. The multilayer structure with the first major surface facing the beam source was conveyed through the electron beam on a carrier web. The multilayer structure was irradiated by electron beam (E-beam) on an ESI CB-300 electron beam system with a dose ranging from 30 kGy to 100 kGy. The electron beam operated at voltages ranging from 140 keV to 300 keV. Two minutes following irradiation, the functionalized membrane was removed from the first and second PET layers. The functionalized membrane was soaked in a tray of water that was exchanged three times with DI water to wash the functionalized membrane of unreacted graftable species and subsequently air dried. Timed flux measurements for Examples 27 and 28 were recorded in Table 7. Similarly, extended water pressure flux measurements for Example 28 were recorded in Table 8.

### Example 29

Comparative Example 23 (CE23) was coated with a solution having 12.5 weight percent (wt. %) sodium 2-acrylamido-2-methyl-1-propanesulfonate (AMPS; concentration of 50-60 wt. % in water) monomer (e.g., graftable species) obtained from Lubrizol Corporation of Wicliffe, Ohio, 20 wt. % methanol (Sigma-Aldrich, St. Louis, Mo.), and 67.5 wt. % (weight percent) deionized (DI) water. The porous substrate was coated with the solution to wet the first major surface, interstitial surfaces and the second major surface. The coated porous substrate was then positioned with the large pore size up (first major surface) and sandwiched ‘wet’ between two layers (removable first and second layers) of PET (polyethylene terephthalate) film having a thickness of 100 micrometers each. The first layer and the second layers of PET were placed on opposing sides of the coated porous substrate to form a multilayer structure with the excess solution and trapped air bubbles squeezed out with a hand held rubber roller. The multilayer structure with the first major surface facing the beam source was conveyed through the electron beam on a carrier web. The multilayer structure was irradiated by electron beam (E-beam) on an ESI CB-300 electron beam system with a dose ranging from 30 kGy to 100 kGy. The electron beam operated at voltages ranging from 140 keV to 300 keV. Two minutes following irradiation, the functionalized membrane was removed from the first and second PET layers. The functionalized membrane was soaked in a tray of water that was exchanged three times with DI water to wash the functionalized membrane of unreacted graftable species and subsequently air dried. Timed flux measurements for Example 29 were recorded in Table 7.

### Example 30

Comparative Example 23 (CE23) was coated with a solution having 12.5 weight percent (wt. %) sodium 2-acrylamido-2-methyl-1-propanesulfonate (AMPS; concentration of 50-60 wt. % in water) monomer (e.g., graftable species) obtained from Lubrizol Corporation of Wicliffe, Ohio, and 87.5 wt. % (weight percent) deionized (DI) water. The porous substrate was coated with the solution to wet the first major surface, interstitial surfaces and the second major surface. The coated porous substrate was then positioned with the small pore size up (second major surface) and sandwiched ‘wet’ between two layers (removable first and second layers) of PET (polyethylene terephthalate) film having a thickness of 100 micrometers each. The first layer and the second layers of PET were placed on opposing sides of the coated porous substrate to form a multilayer structure with the excess solution and trapped air bubbles squeezed out with a hand held rubber roller. The multilayer structure with the second major surface facing the beam source was conveyed through the electron beam on a carrier web. The multilayer structure was irradiated by electron beam (E-beam) on an ESI CB-300 electron beam system with a dose ranging from 30 kGy to 100 kGy. The electron beam operated at voltages ranging from 140 keV to 300 keV. Two minutes following irradiation, the functionalized membrane was removed from the first and second PET layers. The functionalized membrane was soaked in a tray of water that was exchanged three times with DI water to wash the functionalized membrane of unreacted graftable species and subsequently air dried. Timed flux measurements for Example 30 were recorded in Table 7. Similarly, extended water pressure flux measurements for Example 30 were recorded in Table 8.

### Example 31

Comparative Example 23 (CE23) was coated with a solution having 12.5 weight percent (wt. %) sodium 2-acrylamido-2-methyl-1-propanesulfonate (AMPS; concentration of 50-60 wt. % in water) monomer (e.g., graftable species) obtained from Lubrizol Corporation of Wicliffe, Ohio, 20 wt. % methanol (Sigma-Aldrich, St. Louis, Mo.), and 67.5 wt. % (weight percent) deionized (DI) water. The porous substrate was coated with the solution to wet the first major surface, interstitial surfaces and the second major surface. The coated porous substrate was then positioned with the small pore size up (second major surface) and sandwiched ‘wet’ between two layers (removable first and second layers) of PET (polyethylene terephthalate) film having a thickness of 100 micrometers each. The first layer and the second layers of PET were placed on opposing sides of the coated porous substrate to form a multilayer structure with the excess solution and trapped air bubbles squeezed out with a hand held rubber roller. The multilayer structure with the second major surface facing the beam source was conveyed through the electron beam on a carrier web. The multilayer structure was irradiated by electron beam (E-beam) on an ESI CB-300 electron beam system with a dose ranging from 30 kGy to 100 kGy. The electron beam operated at voltages ranging from 140 keV to 300 keV. Two minutes following irradiation, the functionalized membrane was removed from the first and second PET layers. The functionalized membrane was soaked in a tray of water that was exchanged three times with DI water to wash the functionalized membrane of unreacted graftable species and subsequently air dried. Timed flux measurements for Example 31 were recorded in Table 7.

TABLE 7

| | | Water Flux Time | |
|---|---|---|---|
| | E-beam | (sec/100 ml/21 in Hg) | |
| Example | (kGy/keV) | (47 mm) | |
| CE 23 | — | 28 | |
| 27 | 55/180 | 320 | seconds |
| 28 | 60/170 | 312 | seconds |
| 29 | 60/170 | 157 | seconds |
| 30 | 60/170 | >5 | minutes |
| 31 | 60/170 | >5 | minutes |

TABLE 8

| | Pressure | Water Flux |
|---|---|---|
| Example | (psi) | (ml/min) |
| 28 | 10 | 25.5 |
| 30 | 10 | 3.4 |
| | 20 | 5.9 |
| | 30 | 7.2 |
| | 40 | 8.5 |
| | 50 | 10.1 |
| | 60 | 13.0 |
| | 70 | 24.3 |

### Comparative Examples 24-26

### CE24-CE26

A three zone, reinforced asymmetric microporous nylon membrane was made by a process described in U.S. Pat. Nos. 6,513,666; 6,776,940; 6,413,070; and 6,264,044. A single base polymer dope formulation was split into three components and applied to a three-way thermal manipulation apparatus. The dope formulation was heated to three different temperatures to achieve three distinct zones. Each of the temperatures used was selected to produce pore sizes in each zone for forming an asymmetric microporous membrane. The first zone (upper zone) has the largest pore size, the second (middle) zone has an intermediate pore size and the third zone (lower zone) has the smallest pore size. The membrane was a single layer having three consecutive progressively smaller pore size exclusion zones.

Comparative Example 24 (CE24) had an average pore size for the third zone (lower zone) of approximately 0.2 micrometers.

Comparative Example 25 (CE25) had an average pore size for the third zone (lower zone) of approximately 0.65 micrometers.

Comparative Example 26 (CE26) had an average pore size for the third zone (lower zone) of approximately of 1.2 micrometers.

Time flux measurements for CE24-CE26 are listed in Table 9.

### Examples 32-34

Example 32 corresponded to Comparative Example 24 having grafted species as described below.

Example 33 corresponded to Comparative Example 25 having grafted species as described below.

Example 34 corresponded to Comparative Example 26 having grafted species as described below.

Comparative Example 24-26 (CE24-CE26) were independently coated with a solution having 12.5 weight percent (wt. %) sodium 2-acrylamido-2-methyl-1-propanesulfonate (AMPS; concentration of 50-60 wt. % in water) monomer (e.g., graftable species) obtained from Lubrizol Corporation of Wicliffe, Ohio, 20 wt. % methanol (Sigma-Aldrich, St. Louis, Mo.), and 67.5 wt. % (weight percent) deionized (DI) water. The porous substrate was coated with the solution to wet the first major surface, interstitial surfaces and the second major surface. The coated porous substrate was then positioned with the large pore size up (first major surface) and sandwiched ‘wet’ between two layers (removable first and second layers) of PET (polyethylene terephthalate) film having a thickness of 100 micrometers each. The first layer and the second layers of PET were placed on opposing sides of the coated porous substrate to form a multilayer structure with the excess solution and trapped air bubbles squeezed out with a hand held rubber roller. The multilayer structure with the first major surface facing the beam source was conveyed through the electron beam on a carrier web. The multilayer structure was irradiated by electron beam (E-beam) on an ESI CB-300 electron beam system with a dose ranging from 30 kGy to 100 kGy. The electron beam operated at voltages ranging from 140 keV to 300 keV. Two minutes following irradiation, the functionalized membrane was removed from the first and second PET layers. The functionalized membrane was soaked in a tray of water that was exchanged three times with DI water to wash the functionalized membrane of unreacted graftable species and subsequently air dried. Timed flux measurements for Examples 32-34 were recorded in Table 9.

### Comparative Examples 27-28

### CE27-CE28

Double layer combination asymmetric membranes were formed. Comparative Example 27 (CE27) was formed from a combination of Comparative Example 25 (CE25) laminated to Comparative Example 24 (CE24). CE25 was the top layer such that the surface of CE25 having the smallest pore size (dimension) was laminated adjacent to the top surface of CE24 (bottom layer) having the largest pore size. The smallest pore size of double layer combination membrane CE 27 was 0.2 micrometers.

Comparative Example 28 (CE28) was a combination of Comparative Example (CE26) laminated to Comparative Example 25 (CE25). CE 26 was the top layer such that the surface of CE 26 having the smallest pore size was laminated adjacent to the top surface of CE25 (bottom layer) having the largest pore size. The smallest pore size of the double layer combination membrane CE28 was 0.65 micrometers.

Double layer combination membranes of Comparative Examples 27-28 were formed using formulations and processes described in U.S. Pat. No. 3,876,738 and U.S. Defensive Publication T-103,601. Individual layers (three zone membranes) were wet laminated after membrane casting, formation, and water rinsing steps. The wet layers were positioned in physical contact such that the lower surface (smaller pore sizes) of the top layer was in contact with the upper surface (larger pore sizes) of the bottom layer. Trapped air was removed from the laminated layers and the double layer combination membrane was carried through a drying apparatus under restraint to control and minimize shrinking in the crossweb or downweb directions to form the double layer combination membrane. The double layer combination membrane of Comparative Examples 27-28 independently have six independent porous zones with the top surface having the largest pore size progressively extending to smaller pore sizes.

### Examples 35-36

Example 35 corresponded to Comparative Example 27 (CE27) having grafted species as described below.

Example 36 corresponded to Comparative Example 28 (CE28) having grafted species as described below.

Comparative Example 27-28 (CE27-CE28) were independently coated with a solution having 12.5 weight percent (wt. %) sodium 2-acrylamido-2-methyl-1-propanesulfonate (AMPS; concentration of 50-60 wt. % in water) monomer (e.g., graftable species) obtained from Lubrizol Corporation of Wicliffe, Ohio, 20 wt. % methanol (Sigma-Aldrich, St. Louis, Mo.), and 67.5 wt. % (weight percent) deionized (DI) water. The porous substrate of CE 27 and CE28 independently was coated with the solution to wet the first major surface, interstitial surfaces and the second major surface. The coated porous substrate was then positioned with the large pore size up (first major surface) and sandwiched ‘wet’ between two layers (removable first and second layers) of PET (polyethylene terephthalate) film having a thickness of 100 micrometers each. The first layer and the second layers of PET were placed on opposing sides of the coated porous substrate to form a multilayer structure with the excess solution and trapped air bubbles squeezed out with a hand held rubber roller. The multilayer structure with the first major surface facing the beam source was conveyed through the electron beam on a carrier web. The multilayer structure was irradiated by electron beam (E-beam) on an ESI CB-300 electron beam system with a dose ranging from 30 kGy to 100 kGy. The electron beam operated at voltages ranging from 140 keV to 300 keV. Two minutes following irradiation, the functionalized membrane was removed from the first and second PET layers. The functionalized membrane was soaked in a tray of water that was exchanged three times with DI water to wash the functionalized membrane of unreacted graftable species and subsequently air dried. Timed flux measurements for Examples 35-36 were recorded in Table 9.

### Comparative Example 29

### CE29

Triple layer combination asymmetric membranes were formed. Comparative Example 29 (CE29) was a combination of Comparative Example 26 (CE26) (top layer) laminated to Comparative Example 25 (CE25) (intermediate layer) laminated to Comparative Example 24 (CE 24) (bottom layer). The bottom surface of CE26 having the smallest pore size (dimension) was laminated adjacent to the top surface of CE25 (intermediate layer) having the largest pore size, and the top surface of CE 24 (bottom layer) was laminated adjacent to the bottom surface of CE 25 (small pore size) for forming the triple layer combination asymmetric membrane. The smallest pore size of triple layer combination asymmetric membrane CE29 was 0.2 micrometers.

Triple layer combination asymmetric membrane of CE29 was formed using formulations and processes described in U.S. Pat. No. 3,876,738 and U.S. Defensive Publication T-103,601. Individual layers (three zone membranes) were wet laminated after membrane casting, formation, and water rinsing steps. The wet layers were positioned in physical contact such that the lower surface (smaller pore sizes) of the top layer was in contact with the upper surface (larger pore sizes) of the intermediate layer and the lower surface of the intermediate layer (smaller pore sizes) was positioned in contact with the top surface (large pore sizes) of the bottom layer. Trapped air was removed from the three laminated layers and the triple layer combination asymmetric membrane was carried through a drying apparatus under restraint to control and minimize shrinking in the crossweb or downweb directions to form the triple layer combination asymmetric membrane The triple layer combination membrane of Comparative Example 29 had nine independent porous zones with the top surface having the largest pore size progressively extending to smaller pore sizes in the bottom layer.

### Examples 37-38

Example 37 corresponded to Comparative Example 29 (CE29) having grafted species as described below.

Example 38 corresponded to Comparative Example 29 (CE29) having grafted species as described below.

Comparative Example 29 (CE29) was coated with a solution having 12.5 weight percent (wt. %) sodium 2-acrylamido-2-methyl-1-propanesulfonate (AMPS; concentration of 50-60 wt. % in water) monomer (e.g., graftable species) obtained from Lubrizol Corporation of Wicliffe, Ohio, 20 wt. % methanol (Sigma-Aldrich, St. Louis, Mo.), and 67.5 wt. % (weight percent) deionized (DI) water. The porous substrate of CE 29 was coated with the solution to wet the first major surface, interstitial surfaces and the second major surface. The coated porous substrate was then positioned with the large pore size up (top layer up) and sandwiched ‘wet’ between two layers (removable first and second layers) of PET (polyethylene terephthalate) film having a thickness of 100 micrometers each. The first layer and the second layers of PET were placed on opposing sides of the coated porous substrate to form a multilayer structure with the excess solution and trapped air bubbles squeezed out with a hand held rubber roller. The multilayer structure with the first major surface facing the beam source was conveyed through the electron beam on a carrier web. The multilayer structure was irradiated by electron beam (E-beam) on an ESI CB-300 electron beam system with a dose ranging from 30 kGy to 100 kGy. The electron beam operated at voltages ranging from 140 keV to 300 keV. Two minutes following irradiation, the functionalized membrane was removed from the first and second PET layers. The functionalized membrane was soaked in a tray of water that was exchanged three times with DI water to wash the functionalized membrane of unreacted graftable species and subsequently air dried. Timed flux measurements for Examples 37-38 were recorded in Table 9.

### Example 39

Comparative Example 29 (CE29) was coated with a solution having 12.5 weight percent (wt. %) sodium 2-acrylamido-2-methyl-1-propanesulfonate (AMPS; concentration of 50-60 wt. % in water) monomer (e.g., graftable species) obtained from Lubrizol Corporation of Wicliffe, Ohio, 20 wt. % methanol (Sigma-Aldrich, St. Louis, Mo.), and 67.5 wt. % (weight percent) deionized (DI) water. The porous substrate of CE29 was coated with the solution to wet the first major surface, interstitial surfaces and the second major surface. The coated porous substrate was then positioned with the large pore size up (top layer) and sandwiched ‘wet’ between two layers (removable first and second layers) of PET (polyethylene terephthalate) film having a thickness of 100 micrometers each. The first layer and the second layers of PET were placed on opposing sides of the coated porous substrate to form a multilayer structure with the excess solution and trapped air bubbles squeezed out with a hand held rubber roller. The multilayer structure with the second major surface facing the beam source was conveyed through the electron beam on a carrier web. The multilayer structure was irradiated by electron beam (E-beam) on an ESI CB-300 electron beam system with a dose ranging from 30 kGy to 100 kGy. The electron beam operated at voltages ranging from 140 keV to 300 keV. Two minutes following irradiation, the functionalized membrane was removed from the first and second PET layers. The functionalized membrane was soaked in a tray of water that was exchanged three times with DI water to wash the functionalized membrane of unreacted graftable species and subsequently air dried. Timed flux measurements for Example 39 were recorded in Table 9.

TABLE 9

| | | | Membrane | Grafted Species |
|---|---|---|---|---|
| | | | Water Flux Time | Water Flux Time |
| | | | (sec/100 ml/ | (sec/100 ml/ |
| | Caliper | E-beam | 21 in Hg) | 21 in Hg) |
| Example | (μm) | (kGy/keV) | (47 mm) | (47 mm) |
| CE 24 | 152.5 | — | 52 | — |
| CE 25 | 180 | — | 17 | — |
| CE 26 | 175 | — | 2.6 | — |
| 32 | 152.5 | 60/160 | — | 1800 |
| 33 | 180 | 60/170 | — | 28 |
| 34 | 175 | 50/170 | — | 5 |
| CE 27 | 332.5 | — | 77 | — |
| CE 28 | 342.5 | — | 23 | — |
| 35 | 332.5 | 50/220 | — | 960 |
| 36 | 342.5 | 50/220 | — | 21 |
| CE 29 | 497.5 | — | 74 | — |
| 37 | 497.5 | 40/280 | — | 480 |
| 38 | 497.5 | 40/240 | — | 416 |
| 39 | 497.5 | 40/240 | — | 87 |

### Example 40

Comparative Example 29 (CE29) was coated with a solution having 15.0 weight percent (wt. %) [3-(methacryloylamino)propyl] trimethylammonium chloride (MAPTAC) monomer, 15 wt. % methanol, 10 wt. % polyethylene glycol (hydroxyl end groups; average molecular weight 4,000 g/mole (PEG 4000), and 60 wt. % water (all chemicals available from Sigma-Aldrich 1001). The porous substrate of CE 29 was coated with the solution to wet the first major surface, interstitial surfaces and the second major surface. The coated porous substrate was then positioned with the large pore size up (top layer up) and sandwiched ‘wet’ between two layers (removable first and second layers) of PET (polyethylene terephthalate) film having a thickness of 100 micrometers each. The first layer and the second layers of PET were placed on opposing sides of the coated porous substrate to form a multilayer structure with the excess solution and trapped air bubbles squeezed out with a hand held rubber roller. The multilayer structure with the first major surface facing the beam source was conveyed through the electron beam on a carrier web. The multilayer structure was irradiated by electron beam (E-beam) on an ESI CB-300 electron beam system with a dose ranging from 30 kGy to 100 kGy. The electron beam operated at voltages ranging from 140 keV to 300 keV. Two minutes following irradiation, the functionalized membrane was removed from the first and second PET layers. The functionalized membrane was soaked in a tray of water that was exchanged three times with DI water to wash the functionalized membrane of unreacted graftable species and subsequently air dried for forming Example 40.

Example 40 and CE 29 were tested using the Dye Adsorption Test to measure the filtration performance of the membrane in a flow through mode. The Dye Adsorption Test is described in U.S. Pat. No. 4,473,474 (Ostreicher), herein incorporated by reference. The Dye Adsorption Test can be useful for measuring filtration adsorptive capacity, ion exchange effects and other surface phenomenon in filtration media in the presence of a flowing stream of liquid through the membranes.

The Dye Adsorption test method described by Ostreicher was used in a similar apparatus and a test solution containing 50 mM Na₂HPO₄, 140 mM NaCl, and 80 ppm Metanil Yellow Dye. The test solution was flowed at a rate of 30 ml/min using a Masterflex peristaltic pump (model 7016 pump head) and drive unit. The test solution was flowed through the 47 mm discs of Example 40 and CE29 independently mounted in a flow through housing, with an exposed area (inside the sealing o-ring) of approximately 13 square centimeters. Example 40 and CE 29 were mounted independently analysis in the housing with the largest pore size performance zone facing upstream, and the smallest pore size performance zone facing downstream. Spectrophotometic absorbance of the effluent liquid was measured at 455 nm using an LKB Ultrospec II spectrophotometer (model #4050) recorded as a function of time. The test was terminated when the effluent transmittance increased to approximately 1.1 absorbance units (at approximately 25% (20 ppm) of the inlet concentration of an 80 ppm metanil yellow test solution). The adsorptive filtration efficiency as a function of time (measured at a flow rate of 30 ml/minute) was measured. Example 40 showed almost a five times increase in adsorptive filtration efficiency compared to CE29 without grafted species (cationic). CE 29 and Example 40 independently were removed from test apparatus and visually examined. Example 40 showed higher capacity at the upstream surface and greater dye performance in dynamic flow testing through the nylon porous structure at the dyed membrane surfaces in comparison to CE29 (without grafted cationic species).

Various modifications and alterations of this disclosure will be apparent to those skilled in the art without departing from the scope and spirit of this disclosure, and it should be understood that this disclosure is not limited to the illustrative elements set forth herein.

What is claimed is:

1. A method for making a functionalized membrane, the method comprising:
providing a porous substrate having a first major surface, interstitial surfaces and a second major surface;
applying at least one graftable species to the porous substrate to provide a coated porous substrate; and
treating the coated porous substrate with electron beam radiation to provide the functionalized membrane, the electron beam radiation attaching the graftable species to the porous substrate in a gradient comprising grafted species attached to the porous substrate, so that a concentration of the grafted species is greater at the first major surface than at the second major surface.

2. The method of claim 1, wherein the porous substrate is hydrophilic or hydrophobic.

3. The method of claim 1, wherein the porous substrate is selected from the group consisting of a film, a non-woven web, a woven web, and combinations of two or more of the foregoing.

4. The method of claim 1, wherein the porous substrate comprises a microporous, thermally-induced phase separation membrane.

5. The method of claim 4, wherein the thermally-induced phase separation membrane comprises poly(vinylidene fluoride).

6. The method of claim 1, wherein the porous substrate comprises nylon.

7. The method of claim 1, wherein the first major surface of the functionalized membrane is hydrophilic, and the second major surface of the functionalized membrane is hydrophobic.

8. The method of claim 1, wherein the first major surface of the functionalized membrane is hydrophilic, and the second major surface of the functionalized membrane is hydrophobic.

9. The method of claim 1, wherein the at least one graftable species comprises a free-radically polymerizable group.

10. The method of claim 9, wherein the at least one graftable species comprises the free-radically polymerizable group and an additional functional group selected from the group consisting of an ethylenically unsaturated group, an epoxy group, an azlactone group, an ionic group, an alkylene oxide group, and combinations of two or more of the foregoing.

11. The method of claim 10, wherein the ionic group is a sulfonic acid or a sulfonic acid salt.

12. The method of claim 10, wherein the ionic group is an amine or a quaternary ammonium salt.

13. The method of claim 10, wherein the additional functional group reacts with a nucleophilic compound.

14. The method of claim 13, wherein the nucleophilic compound comprises a nucleophilic group selected from the group consisting of a primary amino group, a secondary amino group, a hydroxyl group, a carboxyl group, and combinations of two or more of the foregoing.

15. The method claim 1, wherein the at least one graftable species comprises a functionality of at least 2.

16. The method of claim 1, wherein the at least one graftable species comprises a polyalkylene glycol di(meth)acrylate.

17. The method of claim 1, wherein the at least one graftable species is selected from the group consisting of a glycidyl (meth)acrylate, an isocyanatoalkyl (meth)acrylate, a vinyl azlactone, and combinations or two or more of the foregoing.

18. The method of claim 1, further comprising positioning the coated porous substrate between a first layer and a second layer to form a multilayer structure, the first layer positioned adjacent to the first major surface and the second layer positioned adjacent to the second major surface, and wherein treating the coated porous substrate with electron beam radiation comprises exposing the multilayer structure to the electron beam radiation.

19. The method of claim 18, further comprising removing the first layer and the second layer from the multilayer structure after treating the coated porous substrate with electron beam radiation.

20. The method of claim 1, further comprising positioning a first layer on the coated porous substrate adjacent to the first major surface to form a bilayer structure, and wherein exposing the coated porous substrate to electron beam radiation.

21. The method of claim 20, further comprising removing the first layer from the bilayer structure after treating the coated porous substrate with electron beam radiation.

22. The method of claim 1, further comprising treating the coated porous substrate with an inert atmosphere to provide the functionalized membrane.

23. The method of claim 1, wherein a dose of electron beam radiation delivered to the coated porous substrate is within a range from about 0 kGy to about 120 kGy, inclusively.

24. The method of claim 1 wherein the electron beam radiation is operated at a voltage within a range from about 120 keV to about 250 keV, inclusively.

25. The method of claim 1, wherein a portion of the grafted species forms a gel.

26. The method of claim 1, wherein applying at least one graftable species to the porous substrate comprises applying two graftable species to the porous substrate.

27. The method of claim 26, wherein the two graftable species are applied to the porous substrate at the same time.

28. The method of claim 26, wherein the two graftable species are applied sequentially to the porous substrate, a first graftable species is applied to the porous substrate to provide the coated porous substrate and a second graftable species is applied to the coated porous substrate prior to treating the coated porous substrate with electron beam radiation.

29. The method of claim 1, further comprising applying at least one additional graftable species to the functionalized membrane and thereafter treating the functionalized membrane with a second treatment of electron beam radiation to attach the additional graftable species to the functionalized membrane, the functionalized membrane having at least one additional grafted species.

30. The method of claim 29, wherein the concentration of the at least one additional grafted species is greater at the second major surface than at the first major surface.

31. A method for making a functionalized membrane, the method comprising:
providing a porous substrate having a first major surface, interstitial surfaces and a second major surface;
treating the porous substrate with electron beam radiation to provide an irradiated porous substrate comprising a gradient of initiating sites; and
applying at least one graftable species to the irradiated porous substrate to provide a functionalized membrane, the graftable species attaching to the initiating sites on the porous substrate in a gradient comprising grafted species attached to the porous substrate so that a concentration of the grafted species is greater at the first major surface than at the second major surface.

32. A functionalized membrane comprising:
a porous substrate having a first major surface, interstitial surfaces, and a second major surface; and
grafted species attached to the porous substrate in a gradient extending through the porous substrate from the first major surface to the second major surface so that a concentration of the grafted species is greater at the first major surface than at the second major surface.

33. The functionalized membrane of claim 32, wherein the porous substrate is asymmetric.

34. The functionalized membrane of claim 32, wherein the porous substrate is symmetric.

35. The functionalized membrane of claim 33, wherein an average pore diameter of the first major surface is greater than an average pore diameter of the second major surface.

36. The functionalized membrane of claim 33, wherein an average pore diameter of the first major surface is less than an average pore diameter of the second major surface.
